(19) United States
(12) Patent Application Publication
(10) Pub. No.: US 2020/0140290 A1
(43) Pub. Date: May 7, 2020

(54) Remediation of physiologically active compounds from waste water

(71) Applicant: Secure Natural Resources LLC, Chicago, IL (US)

(72) Inventors: John L. Burba, Parker, CO (US); Charles F. Whitehead, Greenwood Village, CO (US); Carl R. Hassler, Gig Harbor, WA (US); Robert Cable, Las Vegas, NV (US)

(73) Assignee: Secure Natural Resources LLC, Chicago, IL (US)

(21) Appl. No.: 16/425,432

(22) Filed: May 29, 2019

Related U.S. Application Data
(63) Continuation of application No. 13/159,179, filed on Jun. 13, 2011, now abandoned.
(60) Provisional application No. 61/354,031, filed on Jun. 11, 2010.

(51) Int. Cl. C02F 1/28; B01J 20/02; B01J 20/28; B01J 20/32

(52) U.S. Cl. CPC C02F 1/288; B01J 20/0207; C02F 2101/103; B01J 20/3236; B01J 20/2803; B01J 20/28007

(57) ABSTRACT

The present invention is directed to the removal of one or more selected target materials, in particular a physiologically active compound contaminant, from various streams using a rare earth fixing agent.

### CROSS REFERENCE TO RELATED APPLICATION

The present application is a continuation of U.S. application Ser. No. 13/159,179, filed Jun. 13, 2011, which in turn claims the benefits of U.S. Provisional Application Ser. No. 61/354,031, filed Jun. 11, 2010, both having the same title, both of which are incorporated herein by this reference in their entireties.

### FIELD

The invention relates generally to removal, using rare earth metals, of target materials and particularly to removal and/or stabilization, using rare earth metals, of physiologically active materials in wastewater.

### BACKGROUND

Purification or filtration of water or other aqueous solutions is necessary for many applications, from the provision of safe or potable drinking water to biotechnology applications. Concerns have been expressed, especially in Europe and the United States, in recent years regarding the entry of human and animal physiologically active materials into the environment, particularly the entry into fluid streams. The physiologically active materials end up in potable water when they are not adequately removed by municipal treatment systems.

Thus, there is a need for removing physiologically active materials from fluid streams.

### SUMMARY

These and other needs are addressed by the various embodiments and configurations of the present invention. This disclosure relates generally to removal of a physiologically active target material from a fluid and stabilization of the removed physiologically active target material.

In one embodiment, a process is provided that includes the step of contacting a feed stream comprising a physiologically active target material with a soluble fixing agent, the soluble fixing agent comprising a rare earth, to form an insoluble target material-containing fixing agent comprising at least a portion of the physiologically active target material and the rare earth.

In one embodiment, a process is provided that includes the step of contacting a physiologically active compound-containing stream with an insoluble rare earth fixing agent to form an insoluble target material-containing fixing agent comprising at least a portion of the physiologically active target material and the rare earth.

In another embodiment, a solid-phase material is provided that includes:

(a) at least a portion of a physiologically active target material, wherein the physiologically active target material comprises at least one physiologically active compound; and

(b) a rare earth.

The insoluble target material-containing fixing agent is typically in the form of precipitate that can be removed as a solid. In one embodiment, the insoluble target material-containing fixing agent has at least about 0.01 wt. %, preferably at least about 0.1 wt. %, and even more preferably ranges from about 5 to about 50 wt. % of the physiologically active target material. The physiologically active target material is commonly in the form of a chemical compound having a physiological activity to an animal.

Non-limiting examples of soluble rare earth fixing agents are rare earth salts, including without limitation rare earth carbonates, halocarbonates, nitrates, halides, chlorites, chlorates, bromites, bromates, iodites, iodates, nitrites, sulfates, ammonium sulfate, acetates, formates, perchlorates, oxalates, phosphates, phosphites, and mixtures thereof.

Non-limiting examples of insoluble rare earth fixing agents include, without limitation, cerium (III) oxide, cerium (IV) oxide, and mixtures thereof.

A soluble and/or insoluble rare earth fixing agent can include one or more of the rare earths including lanthanum, cerium, praseodymium, neodymium, promethium, samarium, europium, gadolinium, terbium, dysprosium, holmium erbium, thulium, ytterbium and lutetium. In some embodiments, the rare earth fixing agent can comprise one or more of cerium, lanthanum, or praseodymium. Typically, the fixing agent does not include a single rare earth-containing compound but includes two or more rare earth-containing compounds. Such compounds can contain the same or different rare earth elements and can contain mixed valence or oxidation states.

The ability to form the insoluble target material-containing fixing agent in the form of a solid comprising a relatively high concentration of the physiologically active target material can greatly reduce the volume of the insoluble target material-containing fixing agent requiring disposal, thereby reducing disposal costs.

In one application, the physiologically active target material can be selected from the group consisting essentially of prescription drug, over-the-counter therapeutic drug, veterinary drug, fragrance, cosmetic, sun-screen agent, diagnostic agent, nutraceutical, biopharmaceutical active compound, growth enhancing chemical, antimicrobial, estrogenic steroid, antidepressant, selective serotonin reuptake inhibitor, calcium-channel blocker, antiepileptic drug, phenytoin, valproate, carbamazepine, multi-drug transporter, efflux pump, musk aroma chemical, triclosan, genotoxic drug, and mixtures thereof.

In one application, the physiologically active target material comprises one or more of an antipyretics, analgesics, antimalarial drugs, antiseptics, antacids, reflux suppressants, antiflatulents, antidopaminergics, proton pump inhibitors (PPIs), H2-receptor antagonists, cytoprotectants, prostaglandin analogues, laxatives, antispasmodics, antidiarrhoeals, bile acid sequestrants, opioid, β-receptor blockers, calcium channel blockers, diuretics, cardiac glycosides, antiarrhythmics, nitrate, antianginals, vasoconstrictors, vasodilators, peripheral activators, antihypertensive drugs, ACE inhibitors, angiotensin receptor blockers, α blockers, calcium channel blockers, anticoagulants, heparin, antiplatelet drugs, fibrinolytics, anti-hemophilic factors, haemostatic drugs, atherosclerosis/cholesterol inhibitors, hypolipidaemic agents, statins, hypnotics, anaesthetics, antipsychotics, antidepressants, tricyclic antidepressants, monoamine oxidase inhibitors, lithium salts, selective serotonin reuptake inhibitors (SSRIs), antiemetics, anticonvulsants, antiepileptics, anxiolytics, barbiturates, movement disorder drugs, stimulants, amphetamines, benzodiazepines, cyclopyrrolones, dopamine antagonists, antihistamines, cholinergics, anticholinergics, emetics, cannabinoids, 5-HT (serotonin) antagonists, nonsteroidal anti-inflammatory drugs, opioids and various orphans such as paracetamol, tricyclic antidepressants, anticonvulsants, adrenergic neurone blocker, astringent, ocular lubricant, topical anesthetics, sympathomimetics, parasympatholytics, mydriatics, cycloplegics, antibiotics, topical antibiotics, sulfa drugs, aminoglycosides, fluoroquinolones, antiviral drugs, anti-fungal drugs, imidazoles, polyenes, corticosteroids, anti-allergy, mast cell inhibitors, anti-glaucoma, adrenergic agonists, beta-blockers, carbonic anhydrase inhibitors/hyperosmotics, cholinergics, miotics, parasympathomimetics, prostaglandin agonists/prostaglandin inhibitors, nitroglycerin, sympathomimetics, antihistamines, anticholinergics, steroids, antiseptics, local anesthetics, cerumenolyti, bronchodilators, anti-allergics, antitussives, mucolytics, decongestants, Beta2-adrenergic agonists, anticholinergics, androgens, antiandrogens, gonadotropin, human growth hormone, insulin, antidiabetics, sulfonylureas, biguanides, metformin, thiazolidinediones, insulin, thyroid hormones, antithyroid drugs, calcitonin, diphosponate, vasopressin analogues, alkalising agents, quinolones, cholinergics, anticholinergics, anticholinesterases, antispasmodics, 5-alpha reductase inhibitor, selective alpha-1 blockers, sildenafils, fertility medications, ormeloxifene, spermicide, anticholinergics, haemostatic drugs, antifibrinolytics, Hormone Replacement Therapy (HRT), bone regulators, beta-receptor agonists, follicle stimulating hormone, luteinising hormone, LHRH, gamolenic acid, gonadotropin release inhibitor, progestogen, dopamine agonists, oestrogen, prostaglandins, gonadorelin, clomiphene, tamoxifen, Diethylstilbestrol, emollients, anti-pruritics, disinfectants, scabicides, pediculicides, tar products, vitamin A derivatives, vitamin D analogues, keratolytics, abrasives, systemic antibiotics, topical antibiotics, hormones, desloughing agents, exudate absorbents, fibrinolytics, proteolytics, sunscreens, antiperspirants, antibiotics, antileprotics, antituberculous drugs, antimalarials, anthelmintics, amoebicides, antiprotozoals, vaccines, immunoglobulins, immunosuppressants, interferons, monoclonal antibodies, anti-allergics, antihistamines, tonics, iron preparations, electrolytes, parenteral nutritional supplements, vitamins, anti-obesity drugs, anabolic drugs, haematopoietic drugs, food product drugs, barbiturates, HMG-CoA reductase inhibitors, and mixtures thereof.

In one application, the physiologically active target material is one or more of caffeine, acetaminophen, ibuprofen, dimethoprim, trimethoprim, sulfonamide, sulfamethoxazole, bis(2-ethylhexyl)phthalate, diethyl phthalate, cotinine, nicotine, lincomycini, sulfadimethoxine, sulfamethazine, sulfathiazole, tylosin, cholesterol, coprostan-3-ol, dihydrocholesterol, ergosterol, stigmastanol, stigmasterol, bezafibrate, clofibric acid, carbamazepine, diclofenac, naproxen, propranolol, ketoprofen, mefenamic acid, androstenedione, estrone, progesterone, estradiol, pentoxifylline, ethynylestradiol, synthetic estrogen EE2, endogenous estrogen 17β-estradiol (E2) and 17α-ethinylstradiol (EE2), estrone, meprobamate, phenytoin, ethinyl estradiol, mestranol, norethindrone, erythromycine, atenolol, triclosan, bisphenol A, nonylphenol, DEET, iopromide, TCEP, roxithromycin, erythromycin-H₂O, gemfibrozil, meprobamate, phenytoin, fluoxetine, diazepam, ethynylestradiol, atorvastatin, norfluoxetine, o-hydroxy atorvastatin, p-hydroxy atorvastatin, risperiodine, testosterone, risperidone, enalapril, simvastatin, simvastatin hydroxyl acid, clofibrate, phthalate esters, primidone, fluoroquinolones, norfloxacin, ofloxacin, ciprofloxacin, tetracycline, doxycycline, estriol, D-norgestrel, clopidogrel, enoxparin, celecoxib, rofecoxib, valdecoxib, omeprazole, esomeprazole, fexofenadine, quetiapine, metoprolol, budesonide, paracetamol, propylphenazone, acetaminophenone, ibuprofen methyl ester, quinolone, macrolide antibiotics, synthetic steroid hormone, loratadine, cetirizine, and mixtures thereof.

The process may further comprise step (c), contacting the fluid stream with another fixing agent. The other fixing agent comprises at least one of yttrium, scandium, and a lanthanoid. The other fixing agent typically has an oxidation state different from (e.g., higher than, lower than and/or equal to) the oxidation state of the insoluble fixing agent. The oxidation state of the other fixing agent is typically one of +3 or +4. Preferably, the other fixing agent is a soluble fixing agent. More preferably, the soluble fixing agent is a rare earth (III) chloride.

The present invention can include a number of advantages depending on the particular configuration. The process of the present invention can remove variable amounts of physiologically active target materials as needed to comply with application and process requirements. For example, the target material removal process can remove high concentrations of physiologically active materials to produce a treated solution having no more than about 500 ppm, in some cases no more than about 100 ppm, in other cases no more than about 50 ppm, in still other cases no more than about 20 ppb, and in still other cases no more than about 1 ppb physiologically active material. The insoluble rare earth/target material product can be qualified as non-hazardous waste. The physiologically active target material removal process can be relatively insensitive to pH. The disclosed process can effectively fix and/or remove physiologically active materials, from solutions over a wide range of pH levels, as well as at extremely high and low pH values adding flexibility to the selection of materials and processes for removing the physiologically active compounds without significant concern for the pH value of the resulting physiologically active compound-containing product. Further still, elimination of the need to adjust and maintain pH can provide significant cost advantages. The physiologically active material removal and/or fixation process can also be relatively insensitive to the concentration of the physiologically active material in the fluid stream. The process can remove and/or fix relatively low and high levels of physiologically active materials, from fluid streams. The process can be a robust, versatile process.

These and other advantages will be apparent from the disclosure of the aspects, embodiments, and configurations contained herein.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

“Absorption” refers to the penetration of one substance into the inner structure of another, as distinguished from adsorption.

“Adsorption” refers to the adherence of atoms, ions, molecules, polyatomic ions, or other substances of a gas or liquid to the surface of another substance, called the adsorbent. The attractive force for adsorption can be, for example, ionic forces such as covalent, or electrostatic forces, such as van der Waals and/or London's forces.

“Agglomerate” refers to the rare earth(s) and/or rare earth-containing fixing agent nanoparticles and/or particles larger than nanoparticles formed into a cluster with another material, preferably a binder such as a polymeric binder.

“Aggregate” refers to separate units (such as but not limited to nanoparticles and/or particles larger than nanoparticles, or rare earth(s)) and/or rare earth-containing fixing agents gathered together to form a mass, the mass may be in the form of a mass of nanoparticles and/or particles larger than nanoparticles.

“Animal” refers to a living organism that feeds on organic matter. Generally, an animal is any member of the kingdom Animalia comprising multicellular organisms that move voluntarily, digest food internally, and have sensory and nervous systems that allow them to respond rapidly to stimuli. “Animal” includes, without limitation, mammals (including humans), fish, birds, insects, and the like.

The phrases “at least one,” “one or more,” and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. When each one of A, B, and C in the above expressions refers to an element, such as X, Y, and Z, or class of elements, such as X₁-Xₙ, Y₁-Yₘ, and Z₁-Zₒ, the phrase is intended to refer to a single element selected from X, Y, and Z, a combination of elements selected from the same class (e.g., X₁ and X₂) as well as a combination of elements selected from two or more classes (e.g., Y₁ and Zₒ).

A “binder,” refers to a material that promotes cohesion of aggregates, agglomerates, or particles.

“Composition” refers to one or more chemical units composed of one or more atoms, such as a molecule, polyatomic ion, chemical compound, coordination complex, coordination compound, and the like. As will be appreciated, a composition can be held together by various types of bonds and/or forces, such as covalent bonds, metallic bonds, coordination bonds, ionic bonds, hydrogen bonds, electrostatic forces (e.g., van der Waal's forces and London's forces), and the like.

“Deactivate” or “deactivation” includes rendering a target material, nontoxic, nonharmful, or nonpathogenic to humans and/or other animals.

“De-toxify” or “de-toxification” includes rendering a contaminant non-toxic to a living organism, such as, for example, a human and/or other animal. The contaminant may be rendered non-toxic by converting the contaminant into a non-toxic form or species, which may include degradation and/or absorption/adsorption with other compounds to produce a non-toxic agglomerate.

A “fluid” refers to any material or substance that has the ability to one or more flow, take on the shape of a container holding the material or substance, and/or be substantially non-resistant to deformation (that is substantially continually deform under an applied shear stress). The term applies not only to liquids but also to gases and to finely divided solids. Fluids are broadly classified as Newtonian and non-Newtonian depending on their obedience to the laws of classical mechanics.

An “inorganic material” refers to any material substantially devoid of a rare earth that is not an organic material. Examples of inorganic materials include silicates, carbonates, sulfates, and phosphates.

“Insoluble” refers to materials that are intended to be and/or remain as solids in water and are able to be retained in a device, such as a column, or be readily recovered from a batch reaction using physical means, such as filtration. Insoluble materials should be capable of prolonged exposure to water, over weeks or months, with little (<5%) loss of mass.

“Organic carbons” or “organic material” refer to any compound of carbon except such binary compounds as carbon oxides, the carbides, carbon disulfide, etc.; such ternary compounds as the metallic cyanides, metallic carbonyls, phosgene, carbonyl sulfide, etc.; and the metallic carbonates, such as alkali and alkaline earth metal carbonates. Exemplary organic carbons include humic acid, tannins, and tannic acid, polymeric materials, alcohols, carbonyls, carboxylic acids, oxalates, amino acids, hydrocarbons, and mixtures thereof. In some embodiments, the target material is an organic material as defined herein. An alcohol is any organic compound in which a hydroxyl functional group (—OH) is bound to a carbon atom, the carbon atom is usually connected to other carbon or hydrogen atoms. Examples of alcohols include acyclic alcohols, isopropyl alcohol, ethanol, methanol, pentanol, polyhydric alcohols, unsaturated aliphatic alcohols, and alicyclic alcohols, and the like. The carbonyl group is a functional group consisting of a carbonyl (RR′C═O) (in the form without limitation a ketone, aldehyde, carboxylic acid, ester, amide, acyl halide, acid anhydride, or combinations thereof). Examples of organic compounds containing a carbonyl group include aldehydes, ketones, esters, amides, enones, acyl halides, acid anhydrides, urea, and carbamates and derivatives thereof, and the derivatives of acyl chlorides chloroformates and phosgene, carbonate esters, thioesters, lactones, lactams, hydroxamates, and isocyanates. Preferably, the carbonyl group comprises a carboxylic acid group, which has the formula —C(═O)OH, usually written as —COOH or —CO₂H. Examples of organic compounds containing a carboxyl group include carboxylic acid (R—COOH) and salts and esters (or carboxylates) and other derivatives thereof. It can be appreciated that organic compounds include alcohols, carbonyls, and carboxylic acids, where one or more oxygens are, respectively, replaced with sulfur, selenium and/or tellurium.

“Particle” refers to a solid or microencapsulated liquid having a size that ranges from less than one micron to greater than 100 microns, with no limitation in shape.

“Physiologically active” compounds and/or materials (PACs) refer to any material that impacts, changes, or alters a physiological state or condition of an animal.

“Precipitation” refers not only to the removal of at least part of a physiologically active material in the form of insoluble material but also to the immobilization of at least part of a physiologically active material. For example, “precipitation” includes processes, such as adsorption and absorption.

“Rare earth” refers to one or more of yttrium, scandium, lanthanum, cerium, praseodymium, neodymium, samarium, europium, gadolinium, terbium, dysprosium, holmium erbium, thulium, ytterbium, and lutetium. As will be appreciated, lanthanum, cerium, praseodymium, neodymium, samarium, europium, gadolinium, terbium, dysprosium, holmium erbium, thulium, ytterbium, and lutetium are known as lanthanoids.

The terms “remove” or “removing” include the sorption, precipitation, adsorption, absorption, conversion, deactivation, decomposition, degradation, neutralization, and/or killing of a target material.

“Soluble” refers to materials that readily dissolve in water. For purposes of this invention, it is anticipated that the dissolution of a soluble compound would necessarily occur on a time scale of minutes rather than days. For the compound to be considered to be soluble, it is necessary that it has a significantly high solubility product such that upwards of 5 g/L of the compound will be stable in solution.

“Sorb” or “sorption” refers to adsorption and/or absorption.

“Target materials”, as used herein, preferably includes a physiologically active compound as defined herewith. Although the disclosure is discussed primarily with reference to physiologically active compounds, it is to be understood that the teachings of this disclosure apply equally to the other physiologically active compounds and partially metabolized physiologically active compounds and physiologically active compound-containing compounds.

The preceding is a simplified summary of the disclosure to provide an understanding of some aspects of the disclosure. This summary is neither an extensive nor exhaustive overview of the disclosure and its various aspects, embodiments, and configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and configurations of the disclosure are possible utilizing, alone or in combination, one or more of the features set forth above or described in detail below.

### BRIEF DESCRIPTION OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. Further features and advantages will become apparent from the following, more detailed, description of the various aspects, embodiments, and configurations of the disclosure, as illustrated by the drawings referenced below.

FIG. 1 depicts a process flow chart according to an embodiment.

FIG. 2 is a plot of arsenic capacity (mg As/g CeO₂) against various solution compositions.

### DETAILED DESCRIPTION

Overview

In one aspect, the present invention uses an insoluble or soluble fixing agent or both to remove selected physiologically active target material from a fluid. The fixing agent, whether soluble or insoluble, preferably includes one or more rare earths. The physiologically active target material commonly comprises one or more physiologically active compounds (“PACs”)

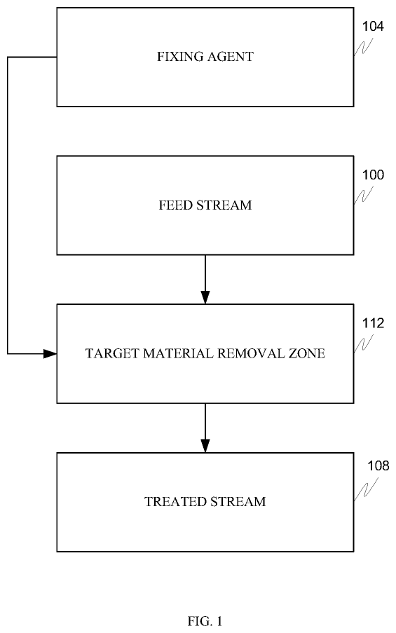

Referring to FIG. 1, a feed stream 100 including one or more dissolved or otherwise solubilized, dispersed, and/or suspended physiologically active target material(s) is contacted with an insoluble and/or soluble rare earth-containing fixing agent(s) 104 in a target material removal zone 112 to form a treated stream 108 that is substantially free of the physiologically active target material(s). The physiologically active material(s) can be present as a PAC or a partially metabolized physiologically active compound, or combination thereof. Specific, non-limiting examples of physiological active materials contained within the feed stream 100 are pharmaceutical(s), hormone(s), caffeine and/or sterol(s). In some instances, the fixing agent can comprise a mixture of fixing agents, the mixture comprising soluble or insoluble fixing agents.

The fixing agent(s) reacts with at least a portion of one or more of the physiologically active compounds to form an insoluble species with the fixing agent. The insoluble species are immobilized, for example, by being sorbed or precipitated, thereby yielding the treated, and substantially purified, stream 108.

Typically, the insoluble and/or soluble fixing agent(s) 104 removes at least most, more commonly at least about 75%, more commonly at least about 80%, more commonly at least about 85%, more commonly at least about 90%, more commonly at least about 95%, and even more commonly at least about 99% of the physiologically active target material.

The Feed Stream

The fluid containing the physiologically active target material is typically in the form of a feed stream 100. The feed stream 100 can be an aqueous stream in the form of a natural or man-made body of water or any other aqueous stream. Non-limiting examples of aqueous streams that can be effectively treated include potable water streams, wastewater treatment streams, and industrial feed, process, municipal waters, or waste streams, to name a few. The described processes, apparatuses, elements, and articles can be used to remove the various physiologically active target materials from solutions having diverse volume and flow rate characteristics and applied in a variety of fixed, mobile, and portable applications.

Generally, the feed stream 100 is an aqueous solution having a pH of at least about pH 1, more generally at least about pH 2, more generally at least about pH 3, more generally at least about pH 4, more generally at least about pH 5, and even more generally at least about pH 6, and a pH of no more than about pH 13, more generally of no more than about pH 12, more generally of no more than about pH 11, more generally of no more than about pH 10, more generally of no more than about pH 9, and even more generally of no more than about pH 8. In some instances, a pH adjustment may be required. The pH, when too high or too low, can cause the soluble fixing agent (discussed below) to precipitate out of solution (e.g., when the pH is too high, the fixing agent can precipitate out of solution as a carbonate or hydroxide and when the pH is too low the fixing agent can precipitate out of solution as a sulfate).

The concentration of the physiologically active target material in the feed stream 100 is typically no more than about 100 ppb, more typically no more than about 50 ppb, and more typically no more than about 1 ppb. In some feed streams, a typical concentration of a physiologically active target material is no more than about 100 ng/L, more typically no more than about 75 ng/L, more typically no more than about 50 ng/L, more typically no more than about 25 ng/L, and even more typically no more than about 20 ng/L.

While portions of this disclosure describe the removal of a physiologically active target material(s) from water, and particularly potable water streams, commonly by precipitation, such references are illustrative and are not to be construed as limiting. For example, the disclosed aspects, embodiments, and configurations can be used to treat fluids other than aqueous and/or water-containing fluids, such as gases, and non-water containing fluids, gases, liquids or mixtures thereof.

Physiologically Active Target Materials

The physiologically active target material is typically an organic material. Examples of physiologically active target materials include, without limitation, pharmaceutical and personal care products used by individuals for personal health or cosmetic reasons or used by agribusiness to enhance growth or health of livestock. PACs include prescription and over-the-counter therapeutic drugs, veterinary drugs, fragrances, cosmetics, pesticides, herbicides, insecticides, rodenticides, hormones, stimulants (such as caffeine), fungicides, pheromones, and their metabolic products having physiological activity in animals. Examples include prescription, veterinary, and over-the-counter (OTC) therapeutic drugs, fragrances, cosmetics, sun-screen agents, diagnostic agents, nutraceuticals, biopharmaceutical compounds, growth enhancing chemicals used in livestock operations, and primary and secondary metabolites, and derivatives of these compounds.

Under the Anatomical Therapeutic Chemical Classification System, pharmaceuticals can be viewed as falling into fourteen main groups, namely alimentary tract and metabolism, blood and blood forming organis, cardiovascular system, dermatologicals, genitor-urinary system and sex hormones, systematic hormonal preparations (excluding sex hormones and insulins), antiinfectives for systematic use, antineoplastic and immunomodulating agents, musculo-skeletal system, nervous system, antiparasitic products, insecticides, and repellants, respiratory system, and sensory organs, and various. Examples of types of pharmaceuticals removable by a rare earth fixing agent include, without limitation, antipyretics, analgesics, antimalarial drugs, antiseptics, antacids, reflux suppressants, antiflatulents, antidopaminergics, proton pump inhibitors (PPIs), H₂-receptor antagonists, cytoprotectants, prostaglandin analogues, laxatives, antispasmodics, antidiarrhoeals, bile acid sequestrants, opioid, β-receptor blockers (“beta blockers”), calcium channel blockers, diuretics, cardiac glycosides, antiarrhythmics, nitrate, antianginals, vasoconstrictors, vasodilators, peripheral activators, antihypertensive drugs (e.g., ACE inhibitors, angiotensin receptor blockers, a blockers, and calcium channel blockers), anticoagulants, heparin, antiplatelet drugs, fibrinolytics, anti-hemophilic factors, haemostatic drugs, atherosclerosis/cholesterol inhibitors (e.g., hypolipidaemic agents and statins), hypnotics, anaesthetics, antipsychotics, antidepressants (including tricyclic antidepressants, monoamine oxidase inhibitors, lithium salts, and selective serotonin reuptake inhibitors (SSRIs)), antiemetics, anticonvulsants/antiepileptics, anxiolytics, barbiturates, movement disorder (e.g., Parkinson's disease) drugs, stimulants (including amphetamines), benzodiazepines, cyclopyrrolones, dopamine antagonists, antihistamines, cholinergics, anticholinergics, emetics, cannabinoids, 5-HT (serotonin) antagonists, nonsteroidal anti-inflammatory drugs (“NSAIDs”), opioids and various orphans such as paracetamol, tricyclic antidepressants, anticonvulsants, adrenergic neurone blocker, astringent, ocular lubricant, topical anesthetics, sympathomimetics, parasympatholytics, mydriatics, cycloplegics, antibiotics, topical antibiotics, sulfa drugs, aminoglycosides, fluoroquinolones, antiviral drugs, anti-fungal drugs (e.g., imidazoles and polyenes), corticosteroids, anti-allergy (e.g., mast cell inhibitors), anti-glaucoma (e.g., adrenergic agonists, beta-blockers, carbonic anhydrase inhibitors/hyperosmotics, cholinergics, miotics, parasympathomimetics, prostaglandin agonists/prostaglandin inhibitors, and nitroglycerin), sympathomimetics, antihistamines, anticholinergics, antiseptics, local anesthetics, cerumenolyti, bronchodilators, anti-allergics, antitussives, mucolytics, decongestants, Beta2-adrenergic agonists, anticholinergics, steroids, androgens, antiandrogens, gonadotropin, human growth hormone, insulin, antidiabetics (sulfonylureas, biguanides/metformin, thiazolidinediones, insulin), thyroid hormones, antithyroid drugs, calcitonin, diphosponate, vasopressin analogues, alkalising agents, quinolones, cholinergics, anticholinergics, anticholinesterases, antispasmodics, 5-alpha reductase inhibitor, selective alpha-1 blockers, sildenafils, fertility medications, ormeloxifene, spermicide, anticholinergics, haemostatic drugs, antifibrinolytics, Hormone Replacement Therapy (HRT), bone regulators, beta-receptor agonists, follicle stimulating hormone, luteinising hormone, LHRH, gamolenic acid, gonadotropin release inhibitor, progestogen, dopamine agonists, oestrogen, prostaglandins, gonadorelin, clomiphene, tamoxifen, Diethylstilbestrol, emollients, anti-pruritics, disinfectants, scabicides, pediculicides, tar products, vitamin A derivatives, vitamin D analogues, keratolytics, abrasives, systemic antibiotics, topical antibiotics, hormones, desloughing agents, exudate absorbents, fibrinolytics, proteolytics, sunscreens, antiperspirants, antibiotics, antileprotics, antituberculous drugs, antimalarials, anthelmintics, amoebicides, antiprotozoals, vaccines, immunoglobulins, immunosuppressants, interferons, monoclonal antibodies, anti-allergics, antihistamines, tonics, iron preparations, electrolytes, parenteral nutritional supplements, vitamins, anti-obesity drugs, anabolic drugs, haematopoietic drugs, food product drugs, barbiturates, HMG-CoA reductase inhibitors, and mixtures thereof.

Common water-borne PAC target materials removable by rare earth fixing agents include antibiotics, antimicrobials, estrogenic steroids, sterols, phenolic compounds, caffeine, antidepressants, selective serotonin reuptake inhibitors, calcium-channel blockers, antiepileptic drugs (e.g., phenytoin, valproate, carbamazepine), multi-drug transporters (efflux pumps), fragrances, musk aroma chemicals, endocrine disrupting compounds, triclosan, sunscreens, antiepileptics, non-steriodal, anti-inflammatory drugs, steroidal hormones, estrogenic hormones, genotoxic drugs, and primary and secondary metabolites and derivatives of these compounds.

Specific examples of water-borne PAC target materials that have been, or may be, detected in terrestrial waters and removable by rare earth fixing agents include caffeine, acetaminophen, ibuprofen, dimethoprim, trimethoprim, sulfonamide (e.g., sulfamethoxazole), bis(2-ethylhexyl)phthalate, diethyl phthalate, azithromycin, cotinine, nicotine, lincomycini, sulfadimethoxine, sulfamethazine, sulfathiazole, tylosin, cholesterol, coprostan-3-ol, dihydrocholesterol, ergosterol, stigmastanol, stigmasterol, bezafibrate, clofibric acid, carbamazepine, oxcarbazepine, gabapentin, diclofenac, naproxen, propranolol, ketoprofen, mefenamic acid, androstenedione, estrone, progesterone, estradiol, pentoxifylline, ethynylestradiol, synthetic estrogen EE2, endogenous estrogen 17β-estradiol (E2) and 17α-ethinylstradiol (EE₂), estrone, 19-norethisterone, trenbolone acetate, meprobamate, phenytoin, ethinyl estradiol, mestranol, norethindrone, erythromycine, atenolol, triclosan, bisphenol A, nonylphenol, DEET, iopromide, TCEP, roxithromycin, erythromycin-H₂O, gemfibrozil, meprobamate, phenytoin, fluoxetine, paroxetine, sertraline, fluvoxamine, escitalopram, diazepam, rohypnol, ethynylestradiol, atorvastatin, fluvastatin, rosuvastatin, norfluoxetine, o-hydroxy atorvastatin, p-hydroxy atorvastatin, risperiodine, testosterone, risperidone, enalapril, quinapril, losartan, simvastatin, simvastatin hydroxyl acid, lovastatin, pravastatin, clofibrate, phthalate esters, primidone, fluoroquinolones, (norfloxacin, ofloxacin, levofloxacin, clinofloxacin, enrofloxacin, and ciprofloxacin), tetracycline (e.g., doxycycline), estriol, D-norgestrel, clopidogrel, enoxparin, celecoxib, rofecoxib, valdecoxib, omeprazole, esomeprazole, fexofenadine, quetiapine, olanzapine, aripiprazoe, metoprolol, nadolol, budesonide, paracetamol, propylphenazone, acetaminophenone, ibuprofen methyl ester, quinolone, macrolide antibiotics, synthetic steroid hormone, venlafaxine, duloxetine, bupropion, loratadine, cetirizine, cimetidine, ranitidine, nizatidine, dmeprazole, lansoprazole, pantoprazole, carboplatin, imatinib, gefitinib, albuterol, bricanyl, montelukast, fluticasone, salmeterol, glyburide, rosiglitazone, pioglitazone, fluconazole, acyclovir, oseltamivir phosphate, ezetimibe, mixtures thereof, and primary and secondary metabolites, and derivatives thereof.

Exemplary water-borne physiologically active target materials that may be successfully removed or reduced in concentration from aqueous sources include those organic compounds containing halogen, sulfate, phosphate, and carbonate chemical substituents. PACs containing fluorine and/or chlorine substituents are exemplary targets for rare earth fixing agents.

These pollutants may find their way into waste water from sources such as human activity, as residues from pharmaceutical manufacturing, as residues from hospitals, as illicit drugs, from veterinary drug use, from residential agriculture or commercial agribusiness, through excretion (the elimination of waste material from the body) and bathing, and disposal of unwanted medications to sewers and trash. These pollutants may become more problematic and may be found in more concentrated and greater absolute amounts as more municipalities turn to waste water recycling as a source of municipal water supplies, particularly in desert and drought affected areas of the world where recycled waste water can account for a substantial proportion of a municipal water supply.

Without intending to be bound by any specific theory, there are at least three potential chemical effects by which these organic compounds are removed from aqueous sources by the rare earth fixing agents, including sequestration or sorption of the organic molecules onto the rare earth fixing agent, degradation of the organic compound into organic substituents having greatly reduced or no physiological activity, and/or a combination of degradation of the organic molecules with certain substituents becoming sequestered with the rare earth fixing agent.

The Rare Earth Fixing Agent

The rare earth fixing agent comprises a rare earth and/or rare earth composition. The rare earth fixing agent can deactivate, sorb, de-toxify, precipitate, and/or remove at least part or a component of a physiologically active target material to form the treated stream 108.

Specific examples of such fixing agents that can remove physiologically active compounds include lanthanum (III) compounds, soluble lanthanum metal salts, lanthanum oxide, cerium dioxide, and soluble cerium salts.

The particular target materials removed depend on whether the fixing agent is insoluble or soluble in an aqueous process, particularly under standard conditions (e.g., Standard Temperature and Pressure “STP”).

The rare earth and/or rare earth fixing agent can be rare earths in elemental, ionic or compounded form. The rare earth and/or rare earth fixing agent can be water soluble or insoluble. As discussed below, the rare earth and/or rare earth fixing agent can be in the form of nanoparticles, particles larger than nanoparticles, agglomerates, or aggregates or combination and/or mixture thereof. The rare earth and/or rare earth fixing agent can be supported or unsupported. The rare earth and/or rare earth fixing agent can comprise one or more rare earths. The rare earths may be of the same or different valence and/or oxidation states and/or numbers, such as the +3 and +4 oxidation states and/or numbers. The rare earths can be a mixture of different rare earths, such as two or more of yttrium, scandium, cerium, lanthanum, praseodymium, and neodymium. The rare earth and/or rare earth fixing agent preferably includes cerium (III) and/or (IV), with cerium (IV) oxide being preferred. In a particular formulation, the rare earth and/or rare earth fixing agent consists essentially of one or more cerium oxides (e.g., cerium (IV) oxide, cerium (III) oxide, and mixtures thereof) and/or of one or more cerium oxides in combination with other rare earths (such as, but not limited to one or more of lanthanum, praseodymium, yttrium, scandium, neodymium, samarium, europium, gadolinium, terbium, dysprosium, holmium, erbium, thulium, ytterbium and lutetium).

In one formulation, the soluble fixing agent is preferably one or more of scandium, yttrium, and a lanthanoid and is in a form that is soluble in water and/or the aqueous leaching agent. The fixing agent can be, without limitation, a soluble salt of scandium, yttrium, or a lanthanoid, with a chloride of cerium (III) or cerium (IV) being preferred. The soluble fixing agent is added, commonly as a separate aqueous solution, to the target material-containing stream preferably in an amount to produce an average molar ratio of fixing agent to target material in solution of less than about 8:1 and more preferably ranging from about 0.5:1 to about 5:1.

The rare earth and/or rare earth fixing agent is, in one application, not a naturally occurring mineral but is synthetically manufactured. Exemplary naturally occurring rare earth-containing minerals include bastnaesite (a carbonate-fluoride mineral) and monazite. Other naturally occurring rare earth-containing minerals include aeschynite, allanite, apatite, britholite, brockite, cerite, fluorcerite, fluorite, gadolinite, parisite, stillwellite, synchisite, titanite, xenotime, zircon, and zirconolite. Exemplary uranium minerals include uraninite (UO₂), pitchblende (a mixed oxide, usually U₃O₈), brannerite (a complex oxide of uranium, rare-earths, iron and titanium), coffinite (uranium silicate), carnotite, autunite, davidite, gummite, torbernite and uranophane. In one formulation, the rare earth and/or rare earth fixing agent is substantially free of one or more elements in Group 1, 2, 4-15, or 17 of the Periodic Table, a radioactive species, such as uranium, sulfur, selenium, tellurium, and polonium.

Soluble Fixing Agent

The rare earth and/or rare earth fixing agent may be formulated as a water-soluble fixing agent. In one formulation, the rare earth fixing agent is water-soluble and preferably includes one or more rare earths, such as cerium and/or lanthanum, the rare earth(s) having a +3 oxidation state. Non-limiting examples of suitable water soluble rare earth compounds include rare earth halides, rare earth nitrates, rare earth sulfates, rare earth oxalates, rare earth halogen oxides, rare earth perchlorates, rare earth carbonates, rare earth acetates, rare earth formates, and mixtures thereof.

A chelating agent can be added with the soluble fixing agent to increase the solubility of the fixing agent in the feed stream 100. A typical chelating agent is a chemical compound containing at least two nonmetal entities capable of binding to a metal atom and/or ion. While not wishing to be bound by any theory, chelating agents function by making several chemical bonds with metal ions. Exemplary chelating agents include ethylene diamine tetra acetic acid (EDTA), dimercaprol (BAL), dimercaptosuccinic acid (DMSA), 2,3-dimercapto-1-propanesulfonic acid (DMPS), and alpha lipoic acid (ALA), aminophenoxyethane-tetraacetic acid (BAPTA), deferasirox, deferiprone, deferoxamine, diethylene triamine pentaacetic acid (DTPA), dimercapto-propane sulfonate (DMPS), dimercaptosuccinic acid (DMSA), ethylenediamine tetraacetic acid (calcium disodium versante) (CaNa₂-EDTA), ethylene glycol tetraacetic acid (EGTA), D-penicillamine, methanesulfonic acid, methanephosphonic acid, and mixtures thereof.

Residual soluble fixing agent dissolved in the aqueous leaching agent can be removed by adding a salt, such as mineral acid salt (e.g., NaCl) or a halide (e.g., an alkali metal or alkaline earth metal fluoride), or selected oxyanion, such as phosphate, to the aqueous leaching agent. Alternatively, the soluble rare earth can be oxidized, such as by sparging with oxygen, to a higher oxidation state, optionally followed by pH adjustment to a higher pH, to precipitate the rare earth as an insoluble compound, such as a rare earth oxide. In another technique, the pH of the aqueous leaching agent is increased, preferably to a pH of at least about pH 7 and even more preferably to a pH of at least about pH 10 to precipitate out the residual soluble fixing agent. The removal of excess soluble fixing agent can occur before or after removal of any precipitated target material.

In one configuration, the contact of the fixing agent with the feed stream 100 is performed using a concentrated and/or acidic rare earth salt solution added at a relatively rapid rate to produce a precipitate that sorbs and/or precipitates more physiologically active target material for a given amount of rare earth. The preferred rare earth salt concentration in the salt solution is preferably at least about 50 g/L, even more preferably from about 100 g/L to about 400 g/L, and even more preferably from about 300 to about 400 g/L. The preferred pH of the salt solution is no more than about pH 2 and even more preferably no more than about pH 0. A particularly preferred formulation includes a solution of cerium in the +3 and/or +4 oxidation state comprising chloride and/or nitrate counter ions.

Insoluble Fixing Agent

The rare earth and/or rare earth fixing agent may be in the form of one or more of a granule, powder, crystal, crystallite, particle and particulate. The rare earth fixing agent may comprise crystals or crystallites and be in the form of a free-flowing granule, powder, and/or particulate. Typically the crystals or crystallites are present as nanocrystals or nanocrystallites. Typically, the rare earth powder has nanocrystalline domains.

The rare earth powder may have a mean, median, and/or P90 particle size of at least about 0.5 nm, ranging up to about 1 μm or more. More typically, the rare earth granule, powder and/or particle has a mean particle size of at least about 1 nm, in some cases at least about 5 nm, in other cases, at least about 10 nm, and still other cases at least about 25 nm, and in yet still other cases at least about 50 nm. In other embodiments, the rare earth powder has a mean, median, and/or P₉₀ particle size in the range of from about 50 nm to about 500 microns and in still other embodiments in the range of from about 50 nm to about 500 nm.

The rare earth fixing agent may be formulated as a rare earth-containing agglomerate or aggregate. In one formulation, the rare earth fixing agent is a free-flowing agglomerate comprising a binder and a rare earth powder having nanocrystalline domains. Furthermore, the rare earth powder may comprise an aggregate or agglomerate of rare earth nanocrystalline domains. Aggregates or agglomerates can comprise rare earth-containing particulates aggregated or agglomerated in a granule, a bead, a pellet, a powder, a fiber, or a similar form.

In a preferred agglomerate or aggregate formulation, the agglomerates or aggregates include an insoluble rare earth fixing agent, preferably, cerium (III) oxide, cerium (IV) oxide, and mixtures thereof, and a soluble rare earth fixing agent, preferably a cerium (III) salt (such as cerium (III) carbonate, cerium (III) halides, cerium (III) nitrate, cerium (III) sulfate, cerium (III) oxalates, cerium (III) perchlorate, cerium (IV) salts (such as cerium (IV) oxide, cerium (IV) ammonium sulfate, cerium (IV) acetate, cerium (IV) halides, cerium (IV) oxalates, cerium (IV) perchlorate, and/or cerium (IV) sulfate), and mixtures thereof) and/or a lanthanum (III) salt or oxide (such as lanthanum (III) carbonate, lanthanum (III) halides, lanthanum (III) nitrate, lanthanum (III) sulfate, lanthanum (III) oxalates, lanthanum (III) oxide, and mixtures thereof).

Depending upon the desired properties of the agglomerate or aggregate, polymer binders can include one or more polymers generally categorized as thermosetting, thermoplastic, elastomer, fluorine-containing polymers, or a combination thereof as well as cellulosic polymers and glasses to at least one of bind, affix, and/or attract the insoluble fixing agent constituents into particulates having one or more of desired size, structure, density, porosity, and fluid properties. The polymers forming the binder may be wet or dry.

Binders include polymeric and/or thermoplastic materials that are capable of softening and becoming “tacky” at elevated temperatures and hardening when cooled. In general, polymers melting between about 50° C. and about 500° C., more particularly, between about 75° C. and about 350° C., even more particularly between about 80° C. and about 200° C., are suitable for use in aggregating the rare earth fixing agent. Non-limiting examples can include polyolefins that soften or melt in the range from about 85° C. to about 180° C., polyamides that soften or melt in the range from about 200° C. to about 300° C., and fluorinated polymers that soften or melt in the range from about 300° C. to about 400° C. The melting point of the polymer binder will preferably not exceed the sintering temperature of the selected insoluble rare earth-containing compound.

Suitable thermosetting polymers include, but are not limited to, polyurethanes, silicones, fluorosilicones, phenolic resins, melamine resins, melamine formaldehyde, and urea formaldehyde.

Suitable thermoplastics can include, but are not limited to, nylons and other polyamides, polyethylenes, including LDPE, LLDPE, HDPE, and polyethylene copolymers with other polyolefins, polyvinylchlorides (both plasticized and unplasticized), fluorocarbon resins, such as polytetrafluoroethylene, polystyrenes, polypropylenes, cellulosic resins such as cellulose acetate butyrates, acrylic resins, such as polyacrylates and polymethylmethacrylates, thermoplastic blends or grafts such as acrylonitrile-butadiene-styrenes or acrylonitrile-styrenes, polycarbonates, polyvinylacetates, ethylene vinyl acetates, polyvinyl alcohols, polyoxymethylene, polyformaldehyde, polyacetals, polyesters, such as polyethylene terephthalate, polyether ether ketone, and phenol-formaldehyde resins, such as resols and novolacs. Those of skill in the art will realize that some of the thermoplastics listed above can also be thermosets depending upon the degree of cross-linking, and that some of each may be elastomers depending upon their mechanical properties. The categorization used above is for ease of understanding and should not be regarded as limiting or controlling.

Suitable elastomers can include, but are not limited to, natural and/or synthetic rubbers, like styrene-butadiene rubbers, neoprenes, nitrile rubber, butyl rubber, silicones, polyurethanes, alkylated chlorosulfonated polyethylene, polyolefins, chlorosulfonated polyethylenes, perfluoroelastomers, polychloroprene (neoprene), ethylene-propylene-diene terpolymers, chlorinated polyethylene, fluoroelastomers, and ZALAK™ (Dupont-Dow elastomer).

In a specific embodiment where the polymer binder comprises an ethylene vinyl copolymer, the insoluble rare earth-containing compound consists essentially of an anhydrous rare earth-containing compound.

Cellulosic polymers can include naturally occurring cellulose such as cotton, paper and wood and chemical modifications of cellulose. In a specific embodiment, the insoluble rare earth-containing compound can be mixed with paper fibers or incorporated directly into paper pulp for forming a paper-based filter comprising the insoluble rare earth-containing compound.

Polymer binders can also include glass materials such as glass fibers, beads and mats. Glass solids may be mixed with particulates of an insoluble rare earth-containing compound and heated until the solids begin to soften or become tacky so that the insoluble rare earth-containing compound adheres to the glass. Similarly, extruded or spun glass fibers may be coated with particles of the insoluble rare earth-containing compound while the glass is in a molten or partially molten state or with the use of adhesives. Alternatively, the glass composition may be doped with the insoluble rare earth-containing compound during manufacture and the rare-earth containing compounds may be deposited or adhered to a substrate material. In some applications, water-soluble glasses may be an appropriate polymer binder.

In other applications, materials that swell through fluid absorption including but not limited to polymers such as synthetically produced polyacrylic acids, and polyacrylamides and naturally-occurring organic polymers such as cellulose derivatives may also be used.

Biodegradable polymers such as polyethylene glycols, polylactic acids, polyvinylalcohols, co-polylactideglycolides, and the like may also be used as the polymer binder.

The agglomerates or aggregates can include one or more flow aids, with or without a binder. Flow aids can improve the fluid dynamics of a fluid over and/or through the agglomerates or aggregates to prevent separation of components, prevent the settling of some particles (e.g., fines), and, in some cases, hold the fixing agent and other components in place. Suitable flow aids can include both organic and inorganic materials. Inorganic flow aids can include ferric sulfate, ferric chloride, ferrous sulfate, aluminum sulfate, sodium aluminate, polyaluminum chloride, aluminum trichloride, silicas, diatomaceous earth and the like. Organic flow aids can include organic flocculents known in the art such as polyacrylamides (cationic, nonionic, and anionic), EPI-DMA's (epichlorohydrin-dimethylamines), DADMAC's (polydiallydimethyl-ammonium chlorides), dicyandiamide/formaldehyde polymers, dicyandiamide/amine polymers, natural guar, etc. When present, the flow aid can be mixed with the insoluble rare earth-containing compound and polymer binder during the formation of the aggregate or agglomerate. Alternatively, particulates of the aggregate or agglomerate and of the flow aid can be mixed to yield a physical mixture with the flow aid dispersed uniformly throughout the mixture. In yet another alternative, the flow aid can be disposed in one or more distinct layers upstream and downstream of the aggregate or agglomerate. When present, flow aids are generally used in low concentrations of less than about 20%, in some cases less than 15%, in other cases less than 10%, and in still other cases less than about 8% by weight of the aggregate or agglomerate.

Other optional components of the aggregate or agglomerate include additives, such as particle surface modification additives, coupling agents, plasticizers, fillers, expanding agents, fibers, antistatic agents, initiators, suspending agents, photosensitizers, lubricants, wetting agents, surfactants, pigments, dyes, UV stabilizers, and suspending agents. The amounts of these materials are selected to provide the properties desired.

The aggregate or agglomerate can be formed though one or more of mixing, extrusion, molding, heating, calcining, sintering, pressing, compaction, the use adhesives and/or other techniques known in the art. In embodiments where it is desired that the aggregate or agglomerate have higher surface areas, sintering is less desired. The use of the polymer binder enables the production of an aggregate or agglomerate of sufficient size, structure and durability for use in the treatment of solutions and gases. The combination of the polymer binder and the insoluble rare earth-containing compound produces an aggregate or agglomerate that has elevated activity for decontaminating fluids without imposing a substantial pressure drop on the treated fluid. The aggregate or agglomerate can comprise a flowable particulate, granule, bead, pellet, powder, fiber, or similar form. The preferred mean, median, or P₉₀ size of the agglomerates or aggregates depend on the application. In most applications, the agglomerates or aggregates preferably have a mean, median, or P₉₀ size of at least about 1 μm, more preferably at least about 5 μm, more preferably at least about 10 μm, still more preferably at least about 25 μm. In other applications, the agglomerate has a mean, median, or P₉₀ particle size distribution from about 100 to about 5,000 microns, a mean, median, or P₉₀ particle size distribution from about 200 to about 2,500 microns, a mean, median, or P₉₀ particle size distribution from about 250 to about 2,500 microns, or a mean, median, or P₉₀ particle size distribution from about 300 to about 500 microns. In other applications, the agglomerates or aggregates can have a mean, median, or P₉₀ particle size distribution of at least about 100 nm, specifically at least about 250 nm, more specifically at least about 500 nm, still more specifically at least about 1 μm and yet more specifically at least about 0.5 nm, ranging up to about 1 micron or more. The agglomerates or aggregates can be crushed, cut, chopped or milled and then sieved to obtain a desired particle size distribution.

Particles of the rare earth fixing agent and the agglomerates and aggregates can have a high surface area. Specifically, the particulates of the rare earth fixing agent and agglomerates or aggregates can have a surface area of at least about 5 m²/g, in other cases at least about 10 m²/g, in other cases at least about 70 m²/g, in other cases at least about 85 m²/g, in other cases at least about 100 m²/g, in other cases at least about 115 m²/g, in other cases at least about 125 m²/g, in other cases at least about 150 m²/g, in still other cases at least 300 m²/g, and in yet other cases at least about 400 m²/g.

The agglomerate or aggregate can vary depending on of the agglomeration or aggregation process. Preferably, the agglomerates or aggregates preferably includes more than 15 wt %, more preferably at least about 20%, more preferably at least about 50%, more preferably more than about 75 wt %, more preferably at least about 90 wt. %, and even more preferably from about 90 to about 98 wt % of the rare earth fixing agent, with the balance being primarily the binder. Stated another way, the binder can be less than about 15% by weight of the agglomerate, in some cases less than about 10% by weight, in still other cases less than about 8% by weight, in still other cases less than about 8% by weight, in still other cases less than about 5% by weight, and in still other cases less than about 3.5% by weight of the agglomerate or aggregate.

In another formulation, the rare earth fixing agent includes nanocrystalline rare earth particles supported on, coated on, or incorporated into a substrate. The nanocrystalline rare earth particles can, for example, be supported or coated on the substrate by a suitable binder, such as those set forth above. Substrates can include porous and fluid permeable solids having a desired shape and physical dimensions. The substrate, for example, can be a sintered ceramic, sintered metal, microporous carbon, glass fiber, cellulosic fiber, alumina, gamma-alumina, activated alumina, acidified alumina, metal oxide containing labile anions, crystalline alumino-silicate such as a zeolite, amorphous silica-alumina, ion exchange resin, clay, ferric sulfate, porous ceramic, and the like. Such substrates can be in the form of mesh, as screens, tubes, honeycomb structures, monoliths, and blocks of various shapes, including cylinders and toroids. The structure of the substrate will vary depending on the application but can include a woven substrate, non-woven substrate, porous membrane, filter, fabric, textile, or other fluid permeable structure. The rare earth and/or rare earth-containing compound(s) in the rare earth fixing agent can be incorporated into or coated onto a filter block or monolith for use in a filter, such as a cross-flow type filter. The rare earth and/or rare earth fixing agent can be in the form of particles coated on to or incorporated in the substrate or can be ionically substituted for cations in the substrate.

The amount of rare earth and/or rare earth fixing agent can depend on the particular substrate and/or binder employed. Typically, the rare earth fixing agent includes at least about 0.1% by weight, more typically 1% by weight, more typically at least about 5% by weight, more typically at least about 10% by weight, more typically at least about 15% by weight, more typically at least about 20% by weight, more typically at least about 25% by weight, more typically at least about 30% by weight, more typically at least about 35% by weight, more typically at least about 40% by weight, more typically at least about 45% by weight, and more typically at least about 50% by weight rare earth and/or rare earth fixing agent. Typically, the rare earth fixing agent includes no more than about 95% by weight, more typically no more than about 90% by weight, more typically no more than about 85% by weight, more typically no more than about 80% by weight, more typically no more than about 75% by weight, more typically no more than about 70% by weight, and even more typically no more than about 65% by weight rare earth and/or rare earth-containing compounds.

In one formulation, the insoluble fixing agent includes a hydrous or anhydrous rare earth oxide, fluoride, carbonate, fluorocarbonate, or silicate of scandium, yttrium, or a lanthanoid, with an oxide of cerium being preferred and cerium (IV) oxide even more preferred. The insoluble fixing agent is preferably a finely divided solid having an average surface area of between about 25 m²/g and about 500 m²/g, more preferably between about 70 m²/g and about 400 m²/g, and even more preferably between about 90 m²/g and about 300 m²/g.

In this formulation, the insoluble fixing agent can be blended with or include other components, such as ion-exchange materials (e.g., synthetic ion exchange resins), porous carbon such as activated carbon, metal oxides (e.g., alumina, silica, silica-alumina, gamma-alumina, activated alumina, acidified alumina, and titania), metal oxides containing labile metal anions (such as aluminum oxychloride), non-oxide refractories (e.g., titanium nitride, silicon nitride, and silicon carbide), diatomaceous earth, mullite, porous polymeric materials, crystalline aluminosilicates such as zeolites (synthetic or naturally occurring), amorphous silica-alumina, minerals and clays (e.g., bentonite, smectite, kaolin, dolomite, montmorillinite, and their derivatives), ion exchange resins, porous ceramics metal silicate materials and minerals (e.g., one of the phosphate and oxide classes), ferric salts, and fibrous materials (including synthetic (for example, without limitation, polyolefins, polyesters, polyamides, polyacrylates, and combinations thereof) and natural (such as, without limitation, plant-based fibers, animal-based fibers, inorganic-based fibers, cellulosic, cotton, paper, glass and combinations thereof).

In a formulation where the insoluble rare earth-containing compound comprises a cerium-containing compound, the cerium-containing compound can be derived from precipitation of a cerium salt or from a cerium carbonate or a cerium oxalate. More specifically, a high surface area insoluble cerium-containing compound can be prepared by thermally decomposing a cerium carbonate or oxalate at a temperature commonly between about 100 to about 700° C., more commonly between about between about 100° C. and about 350° C., and between about 180 and 350° C. in a furnace in the presence of air. The temperature and pressure conditions may be altered depending on the composition of the cerium containing starting material and the desired physical properties of the insoluble rare earth-containing compound. The reaction may be summarized as:

Ce₂(CO₃)₃+½O₂→2CeO₂+3CO₂

The product may be acid treated and washed to remove remaining carbonate. Thermal decomposition processes for producing cerium oxides having various features are described including, but not limited to specific surface areas, pores with uniform lamellar structure, specific particle size distribution, and spherical particles. Cerium carbonate and materials containing cerium carbonate are commercially available and may be obtained from any source known to those skilled in the art.

It should be noted that it is not required to formulate the rare earth fixing agent with either a binder or a substrate, though such formulations may be desired depending on the application.

In another formulation, the fixing agent is coated onto and/or incorporated within a permeable and porous monolith having a plurality of interconnected pores, fluid ingress and egress surfaces and an insoluble rare earth fixing agent within the interconnected pores. The ingress and egress surfaces are in fluid communication via the interconnected pores. The interconnected pores permit a contaminant-containing fluid to flow from the ingress surface, through the interconnected pores, to the egress surface for discharge of the purified fluid. The insoluble rare earth fixing agent within the interconnected pathways removes one or more physiologically active target materials from the feed stream 100 to form the treated stream. The interconnected pores typically have an average pore size from about 0.05 μm to about 1.0 μm. The contaminated fluid enters the apparatus through the ingress surface and discharges through the egress surface.

In one formulation, the solid rare earth fixing agent is in the form of an insoluble rare earth fixing agent. The insoluble rare earth fixing agent comprises from about 1 wt % to about 65 wt % of the monolith containing the solid rare earth fixing agent. The wt % of the monolith containing the insoluble rare earth fixing agent is determined by the following formula:

wt % insoluble rare earth=100*(wt insoluble rare earth contained by monolith)/(wt monolith+wt of solid rare earth fixing agent contained by monolith)

Preferably, from about 10 wt % to about 40 wt % of the rare earth-coated monolith comprises the insoluble rare earth fixing agent. Even more preferably, the wt % of the insoluble rare earth fixing agent is from about 15 to about 25 wt % of the rare earth coated monolith containing the solid rare earth fixing agent.

The insoluble rare earth fixing agent contained by the monolith in the form of one or both of a film and/or a plurality of particles. In one configuration, the insoluble rare earth fixing agent may have an average film thickness from about 0.5 nm to about 500 nm. The insoluble rare earth fixing agent average film thickness is from about 2 nm to about 50 nm. The average film thickness of the insoluble rare earth fixing agent is from about 3 nm to about 20 nm.

The monolith can comprise a ceramic material. The ceramic material is one of an inorganic crystalline oxide material, inorganic non-crystalline oxide material or a combination thereof. Preferably, the ceramic material is one or more of quartz, feldspar, kaolin clay, china clay, clay, alumina, silica, mullite, silicate, kaolinite, ball clay, bone ash, steatite, petuntse, alabaster, zirconia, carbide, boride, silicide, and combinations thereof. More preferably, the ceramic material comprises one of silica, alumina and a combination thereof. In a preferred embodiment, the monolith is sufficiently coated with the rare earth-containing fixing agent to one or both remove enough of one or more of contaminants from the fluid to form the purified fluid stream and to maintain sufficient fluid flow through the insoluble rare earth-coated monolith. That is in a preferred embodiment, the rare earth-containing monolith provides one or more of: fluid flow through the rare earth-containing monolith, minimal pressure drop, and contaminant removal efficiency

The monolith can be manufactured by contacting a monolith having a plurality of interconnected pores with a rare earth-containing solution to form a rare earth-impregnated monolith and calcining the impregnated monolith to form a rare earth coated monolith. The interconnected pores form a plurality of fluid pathways. The rare earth coated monolith has a plurality of rare earth-coated pathways. The rare earth coating the pathways is in the form of an insoluble rare earth fixing agent.

The rare earth-containing solution is impregnated along substantially the entire lengths of the fluid pathways. The rare earth-containing solution can comprise any dissolved rare earth compound in an acidic, pH neutral, or basic solvent for the compound. Preferably, the rare earth-containing solution comprises one of cerium carbonate, nitrate, iodate, sulfate, chlorate, bromate, acetate, formate, and/or oxalate. In a preferred embodiment, the rare earth-containing solution is an aqueous solution.

In one embodiment, the contacting is one of spray coating, curtain coating, immersing, kiss-coating, and coating under greater than atmospheric pressure. Preferably, the monolith is immersed in the rare earth-containing solution. The period of time the monolith is immersed in the rare earth-containing solution is from about 1 hour to about 48 hours.

The Target Material Removal Zone

The target material removal zone can be any contacting zone.

In one configuration, an insoluble fixing agent is contained in one or more columns arranged in series or parallel. The insoluble fixing agent can include a flocculent and/or dispersing agent to maintain a substantially uniform particle distribution in the bed.

In other configurations, the insoluble fixing agent is used in fixed or fluidized beds or reactors, stirred reactors or tanks, distributed in particulate filters, encapsulated or enclosed within membranes, mesh, screens, filters or other fluid permeable, structures, deposited on filter substrates, and may further be formed into a desired shape such as a sheet, film, mat or monolith for various applications.

In other configurations, a container containing the rare earth fixing agent can take a variety of forms including columns, various tanks and reactors, filters, filter beds, drums, cartridges, fluid permeable containers and the like. The container can include one or more of a fixed bed, a fluidized bed, a stirred tank or reactor, or filter, within which the fluid will contact the fixing agent. The container can have a single pass-through design with a designated fluid inlet and fluid outlet or can have fluid permeable outer wall enclosing or encapsulating the aggregate or agglomerate. Where it is desired that the container be flexible in nature, the fluid permeable outer wall can be made from woven or non-woven fabric of various materials. Where a more rigid structure is preferred, the container can be manufactured from metals, plastics such as PVC or acrylic, or other materials that will maintain a desired shape under conditions of use.

In one configuration, the aggregate or agglomerate can be incorporated into or coated onto a filter substrate. Filter substrates can include polymer and non-polymer binder materials as described herein and materials such as ceramics, metals, carbons, and the like. Filler substrates can be made from particulates, fibers, sheets, films and combinations of the same. The structure of a filter substrate will vary depending upon the application but can include any fluid permeable structure having a desired shape and physical dimensions suitable for the conditions of use. Non-limiting examples include mesh, screens, films, sheets, tubes, honeycombed structures, monoliths and blocks of various shapes including cylinders and toroids.

In one configuration, an insoluble fixing agent is contained in a water purification device having an input for the feed stream 100 and outlet for the treated stream. The insoluble fixing agent is commonly incorporated in a removable and replaceable filter or cartridge, such as a carbon block or monolithic filter.

In one configuration, a fixing agent is incorporated into or coated onto a membrane. The membrane can be any hollow fiber membrane. Examples of such membranes are reverse osmosis membranes, ultra-filtration membranes, microfiltration membranes, nanofiltration membranes, hyperfiltration membranes, and the like. The insoluble rare earth-containing membranes can be prepared by impregnating the membrane with a soluble rare earth-containing fixing agent. In one configuration, at least a partial vacuum is applied to the membrane and a rare earth containing solution is “sucked” into the membrane under the reduced pressure. The rare earth-containing membrane is then treated to one or more of: 1) precipitate the rare earth to form an insoluble rare earth and 2) further react the impregnated rare earth to form a rare earth oxide, such as, CeO₂. A non-limiting example of precipitating the impregnated rare earth to form an insoluble rare earth is treating the impregnated rare earth membrane with hydroxide to form a rare earth precipitate within the membrane. A non-limiting example of further reacting the impregnated membrane is reacting an impregnated membrane with a strong oxidant to convert the impregnated rare earth fixing agent to rare earth oxide.

In one configuration, the rare earth fixing agent is distributed over the surface of a solution and allowed to settle through the solution under the influence of gravity. Such an application is particularly useful for reducing the concentration of the physiologically active compounds in solutions found in evaporation tanks, municipal water treatment systems, fountains, ponds, lakes and other natural or man-made bodies of water. In such embodiments, it is preferred but not required that the rare earth fixing agent be filtered or otherwise separated from the solution for disposal or regeneration and re-use.

In other embodiments, the rare earth fixing agent can be introduced into the flow of the aqueous solution such as through a conduit, pipe or the like.

In other configurations, the aggregate or agglomerate can be disposed in a container and the fluid caused to flow through the aggregates or agglomerates. The fluid can be pumped or drawn through the aggregates or agglomerates, with or without agitation or mixing. Various fittings, connections, pumps, valves, manifolds and the like can be used to control the flow of the fluid through the aggregates or agglomerates in a given container.

In one configuration, the aggregate or agglomerate and can be incorporated into or coated onto a filter block or monolith for use in cross-flow type filter.

For some fixing agents, the contacting step may be preceded by an oxidation or reduction step to one of oxidize or reduce the physiologically active target material for better target material removal efficiency and/or affinity of the target material for the insoluble fixing agent.

The target material-loaded fixing agent can be separated from the treated stream by any well known liquid/solid separation technique. Solid/liquid separation is commonly performed by a number of techniques, including filtering, hydrocycloning, screening, centrifuging and gravity separating techniques, such as by counter current decantation and settling. The process can optionally include separating the fluid depleted of contaminants from the target material-loaded fixing agent. The separated fluid depleted of contaminants can then be directed to further processing, storage or use.

Sterilization

After contacting the fluid, the aggregate or agglomerate contains physiologically active target materials. The physiologically active target material-loaded fixing agent comprises REX and/or REOX. (where RE is a rare earth element). In a preferred embodiment, the physiologically active target material-loaded fixing agent comprises cerium, preferably one of CeX and/or CeOX, and combinations thereof. RE comprises one of lanthanum, cerium, praseodymium, neodymium, promethium, samarium, europium, gadolinium, terbium, dysprosium, holmium erbium, thulium, ytterbium and lutetium and O comprises O²⁻. X comprises a physiologically active compound and/or a residue of the physiologically active compound.

The physiologically active target material-loaded fixing agent can be sterilized for re-use or before disposal. The target material-loaded fixing agent can be subjected to steam sterilization or autoclaving as well as to chemical sterilization through contact with oxidative or reductive chemical species. Sterilization processes can include thermal processes wherein the target material-loaded fixing agent is exposed to elevated temperatures or pressures or both, radiation sterilization wherein the target material-loaded fixing agent is subjected to elevated radiation levels using ultraviolet, infrared, microwave, and/or ionizing radiation. In an embodiment where sterilization includes the electrochemical generation of an oxidative or reductive chemical species, the electrical potential necessary to generate said species can be attained by using the aggregate or agglomerate as one of the electrodes. For example, an aggregate or agglomerate that contains a normally insulative polymeric binder can be rendered conductive through the inclusion of a sufficiently high level of conductive particles such as granular activated carbon, carbon black, or metallic particles. Alternatively, if the desired level of carbon or other particles is not sufficiently high to render an otherwise insulative polymer conductive, an intrinsically conductive polymer may included in the binder material. Various glasses such as microporous glass beads and fibers are particularly suited for use as a substrate or binder where the fixing agent is to be periodically regenerated. Combinations of these processes can also be used and it should further be recognized that such sterilization processes may be used on an intermittent or continuous basis while the rare earth fixing agent is in use.

In one process configuration, the target material-loaded rare earth fixing agent is regenerated after removing one or more physiologically active contaminants from the feed stream 100. In one application, a regenerating solution is an alkaline and comprises a strong base. The strong base can comprise an alkali metal hydroxide and group I salt of ammonia, amides, and primary, secondary, tertiary, or quaternary amines, with alkali metal hydroxides being more preferred, and alkali metal hydroxides being even more preferred. While not wishing to be bound by any theory, it is believed that, at high concentrations, hydroxide ions compete with, and displace, at least some, if not most, of the contaminants adsorbed on the insoluble rare earth fixing agent. In one embodiment, the regenerating solution includes a caustic compound in an amount preferably ranging from about 1 to about 15 wt %, even more preferably from about 1 to about 10 wt %, and even more preferably from about 2.5 to about 7.5 wt %, with about 5 wt % being even more preferred.

The preferred pH of the regenerating solution is preferably greater (e.g., more basic) than the pH at which the one or more contaminant was adsorbed onto the insoluble rare earth fixing agent. The regenerating solution pH is preferably at least about pH 10, even more preferably at least about pH 12, and even more preferably at least about pH 14.

In another sterilization process, a first regenerating solution comprises an oxalate or ethanedioate, which, relative to adsorbed one or more contaminants, is preferentially sorbed, over a broad pH range, by the insoluble rare earth fixing agent. In one process variation to desorb oxalate ions, the insoluble rare earth fixing agent is contacted with a second regenerating solution having a preferred pH of at least about pH 9 and even more preferably of at least about pH 11 to desorb oxalate and/or ethanedioate ions in favor of hydroxide ions. A strong base is preferred for the second regenerating solution. Alternatively, the sorbed oxalate and/or ethanedioate anions can be heated to a preferred temperature of at least about 500 degrees Celsius to thermally decompose the sorbed oxalate and/or ethanedioate ions and remove them from the insoluble rare earth fixing agent.

In another sterilization process, a first regenerating solution includes a strongly adsorbing exchange oxyanion, such as phosphate, carbonate, silicate, vanadium oxide, or fluoride, to displace the sorbed contaminant. The first regenerating solution has a relatively high concentration of the exchange oxyanion or fluoride. Desorption of the exchange oxyanion or fluoride is at done at a different (higher) pH and/or exchange oxyanion concentration than the first regenerating solution. For example, desorption can be by a second regenerating solution which includes a strong base and has a lower concentration of the exchange oxyanion than the oxyanion concentration in the first regenerating solution. Alternatively, the exchange oxyanion can be thermally decomposed to regenerate the insoluble rare earth fixing agent. Alternatively, the exchange oxyanion can be desorbed by oxidation or reduction of the insoluble rare earth fixing agent or exchange oxyanion.

In another sterilization process, the regenerating solution includes a reductant or reducing agent, such as ferrous ion, lithium aluminum hydride, nascent hydrogen, sodium amalgam, sodium borohydride, stannous ion, sulfite compounds, hydrazine (Wolff-Kishner reduction), zinc-mercury amalgam, diisobutylaluminum hydride, lindlar catalyst, oxalic acid, formic acid, and a carboxylic acid (e.g., a sugar acid, such as ascorbic acid), to reduce the rare earth, sorbed target material, and/or sorbed target material-containing oxyanion. While not wishing to be bound by any theory nor by way of example, surface reduction of the insoluble rare earth fixing agent will reduce cerium (IV) to cerium (III), which may interact less strongly with target materials and oxyanions. Following or concurrently with surface reduction of the insoluble rare earth fixing agent, the pH is increased to desorb the one or more contaminants.

In another sterilization process, the regenerating solution includes an oxidant or oxidizing agent, e.g., peroxygen compounds (e.g., peroxide, permanganate, persulfate, etc.), ozone, chlorine, hypochlorite, Fenton's reagent, molecular oxygen, phosphate, sulfur dioxide, and the like, that oxidizes the sorbed the one or more contaminants, followed by a pH adjustment and a desorption process. Desorption of the one or more contaminants from the insoluble rare earth fixing agent, for example, typically occurs at a pH of at least about pH 12 and even more typically at least about pH 14.

### EXPERIMENTAL

The following examples are provided to illustrate certain aspects, embodiments, and configurations of the disclosure and are not to be construed as limitations on the disclosure, as set forth in the appended claims. All parts and percentages are by weight unless otherwise specified.

### Example 1

This example demonstrates the affinity of halogens for rare earth metals. A series of tests were performed to determine if certain halogens, particularly fluoride (and other halogens), compete with the binding of arsenic to cerium chloride. Arsenic is known to bind strongly to cerium chloride in aqueous media when using water soluble cerium chloride (CeCl₃). This halogen binding affinity was determined by doing a comparison study between a stock solution containing fluoride and one without fluoride. Materials used were: CeCl₃ (1.194 M Ce or 205.43 g/L REO) and 400 mL of the stock. The constituents of the stock solution, in accordance with NSF P231 “general test water 2” (“NSF”), are shown in Tables 1 and 2:

TABLE 1
Amount of Reagents Added

| | Amount of | Amount of |
|---|---|---|
| | Reagent Added | Reagent Added to |
| Compound | to 3.5 L (g) | 3.5 L (g) No Fluoride |
| NaF | 5.13 | 0 |
| AlCl₃•6H₂O | 0.13 | 0.13 |
| CaCl₂•2 H₂O | 0.46 | 0.46 |
| CuSO₄•5H₂O | 0.06 | 0.06 |
| FeSO₄•7H₂O | 2.17 | 2.16 |
| KCl | 0.16 | 0.15 |
| MgCl₂•6H₂O | 0.73 | 0.74 |
| Na₂SiO₃•9H₂O | 1.76 | 1.76 |
| ZnSO₄•7H₂O | 0.17 | 0.17 |
| Na₂HAsO₄•7H₂O | 18.53 | 18.53 |

TABLE 2
Calculated Analyte Concentrations

| | Theoretical Concentration | Theoretical Concentration |
|---|---|---|
| Element | (mg/L) | (mg/L) No Fluoride |
| Cl | 19032 | 15090 |
| Na | 1664 | 862 |
| K | 24 | 22 |
| Cu | 4 | 4 |
| Fe | 125 | 124 |
| Zn | 11 | 11 |
| As | 1271 | 1271 |
| Mg | 25 | 20 |
| Ca | 36 | 36 |
| Al | 16 | 16 |
| Si | 50 | 50 |
| S | 79 | 79 |
| F | 663 | 0 |

The initial pH of the stock solution was pH approximately 0-1. The temperature of the stock solution was elevated to 70° C. The reaction or residence time was approximately 90 minutes.

The procedure for precipitating cerium arsenate with and without the presence of fluorine is as follows:

Step 1:

Two 3.5 L synthetic stock solutions were prepared, one without fluorine and one with fluorine. Both solutions contained the compounds listed in Table 1.

Step 2:

400 mL of synthetic stock solution was measured gravimetrically (402.41 g) and transferred into a 600 mL Pyrex beaker. The beaker was then placed on hot/stir plate and was heated to 70° C. while being stirred.

Step 3:

Enough cerium chloride was added to the stock solution to meet a predetermined molar ratio of cerium to arsenic. For example, to achieve a molar ratio of one ceria mole to one mole of arsenic 5.68 mL of cerium chloride was measure gravimetrically (7.17 g) and added to the stirring solution. Upon addition of cerium chloride a yellow/white precipitate formed instantaneously, and the pH dropped due to the normality of the cerium chloride solution being 0.22. The pH was adjusted to approximately 7 using 20% sodium hydroxide.

Step 4:

Once the cerium chloride was added to the 70° C. solution, it was allowed to react for 90 minutes before being sampled.

Step 5:

Repeat steps 2-4 for all desired molar ratios for solution containing fluoride and without fluoride.

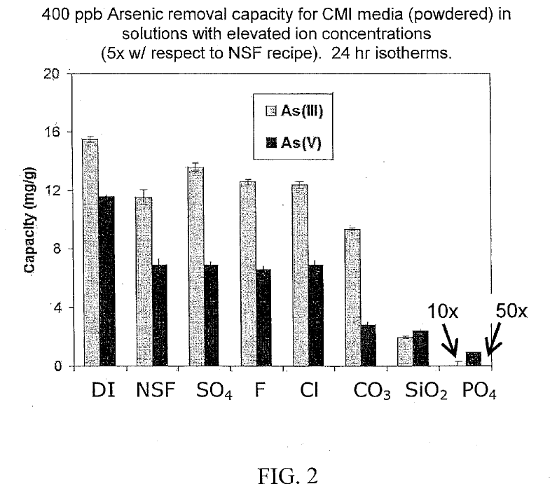

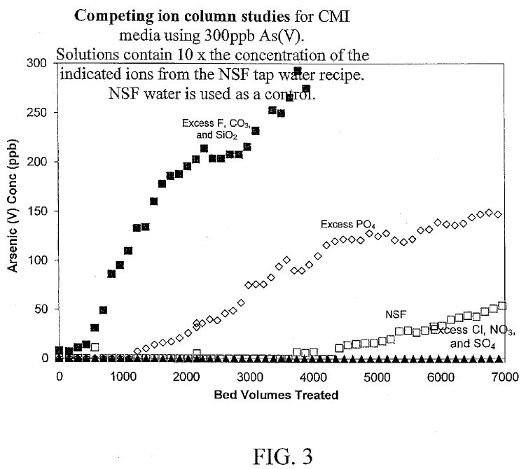

The results are presented in Table 3, FIG. 2 of the present application, and FIG. 3 of U.S. patent application Ser. No. 13/159,179, which is incorporated herein by reference.

TABLE 3
The residual arsenic concentration in supernatant solution
after precipitation with cerium chloride solution.

| | Residual As Concentration | Residual As Concentration |
|---|---|---|
| Molar Ratio | w/Fluoride Present (mg/L) | no Fluoride Present (mg/L) |
| 1.00 | 578 | 0 |
| 1.10 | 425 | 0 |
| 1.20 | 286 | 0 |
| 1.30 | 158.2 | 0 |
| 1.40 | 58.1 | 0 |
| 1.50 | 13.68 | 0 |
| 1.60 | 3.162 | 0 |
| 1.71 | 0 | 0 |
| 1.81 | 10.2 | 0 |
| 1.90 | 0 | 0 |
| 2.01 | 0 | 0 |

A comparison of loading capacities for solutions containing or lacking fluoride shows a strong affinity for halogens and halogenated compounds. FIG. 2 of the present application shows the affinity of cerium III for fluoride in the presence of arsenic. FIG. 3 of U.S. patent application Ser. No. 13/159,179, which is incorporated herein by reference, shows that the loading capacities (which is defined as mg of As per gram of CeO₂) for solutions lacking fluoride are considerably higher at low molar ratios of cerium to arsenic. Sequestration of fluorinated organic compounds, particularly fluorinated pharmaceutical compounds, using rare earth metals, and particularly cerium, is clearly indicated.

Solutions with a cerium to arsenic molar ratio of approximately 1.4 to 1 or greater had a negligible difference in the loading capacities between solution that contained F⁻ and not having F. This leads one to believe that an extra 40% cerium was needed to sequester the F⁻; then the remaining cerium could react with the arsenic.

These results confirm that the presence of fluoride effectively competes with the sequestration of arsenic. The interference comes from the competing reaction forming CeF₃; this reaction has a much more favorable Ksp. In light of these results, an arsenic-free aqueous solution gives better removal of fluorinated compounds.

### Example 2

This example demonstrates the successful removal of sulfate-containing compounds, halogenated compounds, carbonate-containing compounds, and phosphate-containing compounds, using a cerium dioxide powder. A cerium powder, having a 400 ppb arsenic removal capacity, was contacted with various solutions containing arsenic (III) as arsenite and arsenic (V) as arsenate and elevated concentrations of the compounds that compete for the known binding affinity between arsenic and cerium. The competing organic compounds included sulfate ions, fluoride ions, chloride ions, carbonate ions, silicate ions, and phosphate ions at concentrations of approximately 500% of the corresponding NSF concentration for the ion. The cerium dioxide powder was further contacted with arsenic-contaminated distilled and NSF P231 “general test water 2” (“NSF”) water. Distilled water provided the baseline measurement.

The results are presented in FIG. 2. As can be seen from FIG. 2, the ions in NSF water caused, relative to distilled water, a decreased cerium dioxide capacity for both arsenite and arsenate, indicating a successful binding of these compounds to the rare earth metal. The presence of carbonate ion decreased the cerium dioxide removal capacity for arsenate more than arsenite. The presence of silicate ion decreased substantially cerium dioxide removal capacities for both arsenite and arsenate. Finally, phosphate ion caused the largest decrease in cerium dioxide removal capacities for arsenite (10×NSF concentration) and arsenate (50×NSF concentration), with the largest decrease in removal capacity being for arsenite.

### Example 3

Additional competing ion column studies were performed for a 300 ppb arsenate solution and the cerium powder of the prior experiment. The solution contained ten times the concentrations of fluoride ion, chloride ion, carbonate ion, sulfate ion, silicate ion, nitrate ion, and phosphate ion relative to the NSF standard.

The results are shown in FIG. 3 of U.S. patent application Ser. No. 13/159,179, which is incorporated herein by reference. The greatest degree of arsenate competitive binding was experienced in the solutions containing elevated levels of chloride, nitrate, and sulfate ion. The next greatest degree of arsenate removal was for the solution containing elevated levels of phosphate ions.

### Example 4

This example demonstrates the removal of specific physiologically-active compounds from aqueous media using rare earth metals. A series of tests were performed to determine if certain organic compounds were removed from water following exposure to cerium oxide.

Media Preparation:

20 mg of Molycorp HSA cerium oxide was measured out in a plastic weigh boat for each sample to be tested. Approximately 10 mL of DI was added to the weigh boat and the media was allowed to wet for 30 minutes.

Influent Preparation:

30 mL Stock solutions were prepared from solid or liquid reagents for each of the reagents in question. Influents were prepared from the stock solutions in 2.5 L batches for each reagent in question. 2.5 L of DI was measured out gravimetrically into a 4 L bottle. HEPES sodium buffer was added to the DI water followed by 2.5 mL of the stock solutions. The pH was adjusted to 7.5±0.25 using 1 N HCl and 1 N NaOH.

Isotherm Preparation:

500 mL of influent was measured out gravimetrically into four 500 mL bottles. Three bottles were labeled as a samples and the last was labeled as a control. The previously prepared media was poured into each sample bottle. Bottles were capped and sealed with electrical tape. Each bottle was then placed within a rolling container that could hold up to 10 bottles. The containers were then sealed with duct tape and placed on the rolling apparatus. Samples and controls were rolled for 24 hours. After 24 hours, the rolling containers were removed from the apparatus and the bottles were retrieved from the containers. A 10-45 mL sample of each solution was taken and filtered with a 0.2 μm filter. Samples were analyzed by either by a third party laboratory or a HACH colorimeter.

Phosphorus Compound Analysis:

Total phosphorus was analyzed with a HACH DR/890 colorimeter according to the HACH Method 8190 for total phosphorus as phosphate. Briefly, the sample is pretreated with sulfuric acid and persulfate under heat to hydrolyze organic and inorganic phosphorus to orthophosphate, then reacted with molybdate in an acid medium to produce a phosphomolybdate complex. The sample is then reduced with ascorbic acid, resulting in a blue-colored compound which is measured spectroscopically.

Nitrogen Compound Analysis:

Total nitrogen was analyzed with a HACH DR/890 colorimeter according to the HACH Method 10071 for total nitrogen as N. Briefly, the all forms of nitrogen in the sample are converted to nitrate through an alkaline persulfate digestion, followed by the addition of sodium metabisulfite to eliminate halogen oxide interferences. The nitrate is then reacted with chromotropic acid under strongly acidic conditions to produce a yellow-colored compound which is measured spectroscopically.

Benzene Analysis:

Benzene concentration was analyzed by an ICP-MS method.

Table 4 shows the capacity of cerium to remove nine different physiologically-active compounds from aqueous media. The compounds successfully tested include Benzene, 1,7-Dimethylxanthine, Caffeine, Theobromide, Theophylline, DMPA (Dimethylphosphinic Acid), Glyphosate, Pform (Sodium Phosphonoformate tribasic hexahydrate), and TDMAP (Tris(dimethylamino) phosphine).

TABLE 4
Removal of pharmacologically active compounds from aqueous media by cerium.

| | Reagent | | | | | | | | | | Removal |
|---|---|---|---|---|---|---|---|---|---|---|---|
| | Phase | | Volume | Reagent | | Test | Media | Initial | Final | | Capacity |
| | (solid/ | Reagent | Water | Mass | Dilution | Volume | Mass | Reagent | Reagent | Percent | (mg/g |
| Compound | liquid) | Concentration | (L) | (g) | Factor | (L) | (g) | (μg/L) | (μg/L) | Removal | media) |
| Benzene | Liquid | 99% | 0.030 | 0.1497 | 1001 | 0.50 | 0.0197 | 465 | 444 | 4.6 | 0.53 |
| 1,7- | Solid | 98% | 0.030 | 0.0519 | 1001 | 0.50 | 0.0210 | 1833 | 1340 | 26.9 | 12 |
| Dimethylxanthine | | | | | | | | | | | |
| Caffeine | Solid | 100% | 0.030 | 0.0531 | 1035 | 0.50 | 0.0236 | 1629 | 1086 | 33.3 | 12 |
| Theobromide | Solid | 99% | 0.030 | 0.0471 | 1002 | 0.50 | 0.0223 | 2444 | 954 | 61.0 | 33 |
| Theophylline | Solid | 99% | 0.030 | 0.0490 | 1004 | 0.50 | 0.0219 | 1190 | 1018 | 14.4 | 3.9 |
| DMPA | Solid | 97% | 0.030 | 0.0167 | 1001 | 0.50 | 0.0221 | 604 | 538 | 10.9 | 1.5 |
| Glyphosate | Solid | 99% | 0.030 | 0.0250 | 1027 | 0.50 | 0.0185 | 1371 | 926 | 32.5 | 12.0 |
| Pform | Solid | 97% | 0.030 | 0.0369 | 1000 | 0.50 | 0.0207 | 1738 | 1506 | 13.3 | 5.6 |
| TDMAP | Liquid | 97% | 0.030 | 0.0790 | 1002 | 0.50 | 0.0176 | 2784 | 1730 | 37.9 | 29.9 |

A number of variations and modifications of the disclosure can be used. It would be possible to provide for some features of the disclosure without providing others.

For example in one alternative embodiment, the various processes are applied to other fluids, such as gases.

The present disclosure, in various aspects, embodiments, and configurations, includes components, methods, processes, systems and/or apparatus substantially as depicted and described herein, including various aspects, embodiments, configurations, subcombinations, and subsets thereof. Those of skill in the art will understand how to make and use the various aspects, aspects, embodiments, and configurations, after understanding the present disclosure. The present disclosure, in various aspects, embodiments, and configurations, includes providing devices and processes in the absence of items not depicted and/or described herein or in various aspects, embodiments, and configurations hereof, including in the absence of such items as may have been used in previous devices or processes, e.g., for improving performance, achieving ease and\or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more, aspects, embodiments, and configurations for the purpose of streamlining the disclosure. The features of the aspects, embodiments, and configurations of the disclosure may be combined in alternate aspects, embodiments, and configurations other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed aspects, embodiments, and configurations. Thus, the following claims are hereby incorporated into this Detailed Description, with each claim standing on its own as a separate preferred embodiment of the disclosure.

Moreover, though the description of the disclosure has included description of one or more aspects, embodiments, or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

1-21. (canceled)

22. A method, comprising:
contacting a feed stream comprising a physiologically active target material other than nitrate, iodine, selenium, and bis(2-ethylhexyl)phthalate selected from the group consisting of prescription drug, over-the-counter therapeutic drug, veterinary drug, fragrance, cosmetic, sunscreen agent, diagnostic agent, nutraceutical, biopharmaceutical active compound, growth enhancing chemical, antimicrobial, estrogenic steroid, antidepressant, selective serotonin reuptake inhibitor, calcium-channel blocker, antiepileptic drug, phenytoin, valproate, carbamazepine, multi-drug transporter, efflux pump, musk aroma chemical, triclosan, genotoxic drug, and mixtures thereof with at least one of a soluble and insoluble rare earth fixing agent to substantially reduce physiologically active target material in the feed stream.

23. The method of claim 22, wherein the at least one of a soluble and insoluble rare earth fixing agent comprises at least one of yttrium, scandium, lanthanum, cerium, praseodymium, neodymium, promethium, samarium, europium, gadolinium, terbium, dysprosium, holmium erbium, thulium, ytterbium, and lutetium,
forming an insoluble rare earth target material-containing fixing agent comprising at least a portion of the physiologically active target material, wherein the insoluble target material-containing rare earth fixing agent is formed from contacting the feed stream with the at least one of the soluble and insoluble rare earth fixing agent, wherein the physiologically active target material comprises one or more of an antipyretics, analgesics, antimalarial drugs, antacids, reflux suppressants, antiflatulents, antidopaminergics, proton pump inhibitors (PPIs), H2-receptor antagonists, cytoprotectants, prostaglandin analogues, laxatives, antispasmodics, antidiarrhoeals, bile acid sequestrants, opioid, β-receptor blockers, calcium channel blockers, diuretics, cardiac glycosides, antiarrhythmics, antianginals, vasoconstrictors, vasodilators, peripheral activators, antihypertensive drugs, ACE inhibitors, angiotensin receptor blockers, α blockers, calcium channel blockers, anticoagulants, heparin, antiplatelet drugs, fibrinolytics, anti-hemophilic factors, haemostatic drugs, atherosclerosis/cholesterol inhibitors, hypolipidaemic agents, statins, hypnotics, anaesthetics, antipsychotics, antidepressants, tricyclic antidepressants, monoamine oxidase inhibitors, selective serotonin reuptake inhibitors (SSRIs), antiemetics, anticonvulsants, antiepileptics, anxiolytics, barbiturates, movement disorder drugs, stimulants, amphetamines, benzodiazepines, cyclopyrrolones, dopamine antagonists, antihistamines, cholinergics, anticholinergics, emetics, cannabinoids, 5-HT (serotonin) antagonists, nonsteroidal anti-inflammatory drugs, opioids and various orphans, paracetamol, tricyclic antidepressants, anticonvulsants, adrenergic neurone blocker, astringent, ocular lubricant, topical anesthetics, sympathomimetics, parasympatholytics, mydriatics, cycloplegics, antibiotics, topical antibiotics, sulfa drugs, aminoglycosides, fluoroquinolones, antiviral drugs, anti-fungal drugs, imidazoles, polyenes, corticosteroids, anti-allergy, mast cell inhibitors, anti-glaucoma, adrenergic agonists, beta-blockers, carbonic anhydrase inhibitors/hyperosmotics, cholinergics, miotics, parasympathomimetics, prostaglandin agonists/prostaglandin inhibitors, nitroglycerin, sympathomimetics, antihistamines, anticholinergics, steroids, local anesthetics, cerumenolyti, bronchodilators, anti-allergics, antitussives, mucolytics, decongestants, Beta2-adrenergic agonists, anticholinergics, androgens, antiandrogens, gonadotropin, human growth hormone, insulin, antidiabetics, sulfonylureas, biguanides, metformin, thiazolidinediones, insulin, thyroid hormones, antithyroid drugs, calcitonin, diphosponate, vasopressin analogues, alkalising agents, quinolones, cholinergics, anticholinergics, anticholinesterases, antispasmodics, 5-alpha reductase inhibitor, selective alpha-1 blockers, sildenafils, fertility medications, ormeloxifene, spermicide, anticholinergics, haemostatic drugs, antifibrinolytics, Hormone Replacement Therapy (HRT), bone regulators, beta-receptor agonists, follicle stimulating hormone, luteinising hormone, LHRH, gamolenic acid, gonadotropin release inhibitor, progestogen, dopamine agonists, oestrogen, prostaglandins, gonadorelin, clomiphene, tamoxifen, Diethylstilbestrol, emollients, anti-pruritics, disinfectants, scabicides, pediculicides, tar products, vitamin A derivatives, vitamin D analogues, keratolytics, abrasives, systemic antibiotics, topical antibiotics, hormones, desloughing agents, exudate absorbents, fibrinolytics, proteolytics, sunscreens, antiperspirants, antibiotics, antileprotics, antituberculous drugs, antimalarials, anthelmintics, amoebicides, antiprotozoals, vaccines, immunoglobulins, immunosuppressants, interferons, monoclonal antibodies, anti-allergies, antihistamines, tonics, iron preparations, parenteral nutritional supplements, vitamins, anti-obesity drugs, anabolic drugs, haematopoietic drugs, food product drugs, barbiturates, HMG-CoA reductase inhibitors, and mixtures thereof.

24. The method of claim 22, wherein the at least one physiologically active compound is selected from the group consisting essentially of prescription, over-the-counter therapeutic drug, veterinary drug, diagnostic agent, nutraceutical, biopharmaceutical active compound, growth enhancing chemical, estrogenic steroid, antidepressant, selective serotonin reuptake inhibitor, calcium-channel blocker, antiepileptic drug, phenytoin, valproate, carbamazepine, multi-drug transporter, efflux pump, triclosan, genotoxic drug, and mixtures thereof.

25. The method of claim 22, wherein the at least one of a soluble and insoluble rare earth fixing agent comprises a rare earth selected from the group consisting of at least one of yttrium, scandium, lanthanum, cerium, praseodymium, neodymium, promethium, samarium, europium, gadolinium, terbium, dysprosium, holmium erbium, thulium, ytterbium, lutetium, and mixtures thereof.

26. The method of claim 22, wherein the physiologically active target material comprises one or more of an antipyretics, analgesics, antimalarial drugs, antacids, reflux suppressants, antiflatulents, antidopaminergics, proton pump inhibitors (PPIs), H2-receptor antagonists, cytoprotectants, prostaglandin analogues, laxatives, antispasmodics, antidiarrhoeals, bile acid sequestrants, opioid, β-receptor blockers, calcium channel blockers, diuretics, cardiac glycosides, antiarrhythmics, antianginals, vasoconstrictors, vasodilators, peripheral activators, antihypertensive drugs, ACE inhibitors, angiotensin receptor blockers, α blockers, calcium channel blockers, anticoagulants, heparin, antiplatelet drugs, fibrinolytics, anti-hemophilic factors, haemostatic drugs, atherosclerosis/cholesterol inhibitors, hypolipidaemic agents, statins, hypnotics, anaesthetics, antipsychotics, antidepressants, tricyclic antidepressants, monoamine oxidase inhibitors, selective serotonin reuptake inhibitors (SSRIs), antiemetics, anticonvulsants, antiepileptics, anxiolytics, barbiturates, movement disorder drugs, stimulants, amphetamines, benzodiazepines, cyclopyrrolones, dopamine antagonists, antihistamines, cholinergics, anticholinergics, emetics, cannabinoids, 5-HT (serotonin) antagonists, nonsteroidal anti-inflammatory drugs, opioids and various orphans, paracetamol, tricyclic antidepressants, anticonvulsants, adrenergic neurone blocker, astringent, ocular lubricant, topical anesthetics, sympathomimetics, parasympatholytics, mydriatics, cycloplegics, antibiotics, topical antibiotics, sulfa drugs, aminoglycosides, fluoroquinolones, antiviral drugs, anti-fungal drugs, imidazoles, polyenes, corticosteroids, anti-allergy, mast cell inhibitors, anti-glaucoma, adrenergic agonists, beta-blockers, carbonic anhydrase inhibitors/hyperosmotics, cholinergics, miotics, parasympathomimetics, prostaglandin agonists/prostaglandin inhibitors, nitroglycerin, sympathomimetics, antihistamines, anticholinergics, steroids, local anesthetics, cerumenolyti, bronchodilators, anti-allergics, antitussives, mucolytics, decongestants, Beta2-adrenergic agonists, anticholinergics, androgens, antiandrogens, gonadotropin, human growth hormone, insulin, antidiabetics, sulfonylureas, biguanides, metformin, thiazolidinediones, insulin, thyroid hormones, antithyroid drugs, calcitonin, diphosponate, vasopressin analogues, alkalising agents, quinolones, cholinergics, anticholinergics, anticholinesterases, antispasmodics, 5-alpha reductase inhibitor, selective alpha-1 blockers, sildenafils, fertility medications, ormeloxifene, spermicide, anticholinergics, haemostatic drugs, antifibrinolytics, Hormone Replacement Therapy (HRT), bone regulators, beta-receptor agonists, follicle stimulating hormone, luteinising hormone, LHRH, gamolenic acid, gonadotropin release inhibitor, progestogen, dopamine agonists, oestrogen, prostaglandins, gonadorelin, clomiphene, tamoxifen, Diethylstilbestrol, emollients, anti-pruritics, disinfectants, scabicides, pediculicides, tar products, vitamin A derivatives, vitamin D analogues, keratolytics, abrasives, systemic antibiotics, topical antibiotics, hormones, desloughing agents, exudate absorbents, fibrinolytics, proteolytics, sunscreens, antiperspirants, antibiotics, antileprotics, antituberculous drugs, antimalarials, anthelmintics, amoebicides, antiprotozoals, vaccines, immunoglobulins, immunosuppressants, interferons, monoclonal antibodies, anti-allergics, antihistamines, tonics, iron preparations, parenteral nutritional supplements, vitamins, anti-obesity drugs, anabolic drugs, haematopoietic drugs, food product drugs, barbiturates, HMG-CoA reductase inhibitors, and mixtures thereof.

27. The method of claim 22, wherein the at least one of a soluble and insoluble rare earth comprises at least one of yttrium, scandium, lanthanum, cerium, praseodymium, neodymium, promethium, samarium, europium, gadolinium, terbium, dysprosium, holmium erbium, thulium, ytterbium, and lutetium and further comprising:
forming an insoluble target material-containing rare earth fixing agent comprising at least a portion of the physiologically active target material, wherein the insoluble target material-containing rare earth fixing agent is formed from contacting the feed stream with the soluble rare earth fixing agent, wherein the physiologically active target material comprises one or more of caffeine, acetaminophen, ibuprofen, dimethoprim, trimethoprim, sulfonamide , sulfamethoxazole, diethyl phthalate, cotinine, nicotine, lincomycini, sulfadimethoxine, sulfamethazine, sulfathiazole, tylosin, cholesterol, coprostan-3-ol, dihydrocholesterol, ergosterol, stigmastanol, stigmasterol, bezafibrate, clofibric acid, carbamazepine, diclofenac, naproxen, propranolol, ketoprofen, mefenamic acid, androstenedione, estrone, progesterone, estradiol, pentoxifylline, ethynylestradiol, synthetic estrogen EE2, endogenous estrogen 17β-estradiol (E2) and 17α-ethinylstradiol (EE2), estrone, meprobamate, phenytoin, ethinyl estradiol, mestranol, norethindrone, erythromycine, atenolol, triclosan, bisphenol A, nonylphenol, DEET, iopromide, TCEP, roxithromycin, erythromycin-H₂O, gemfibrozil, meprobamate, phenytoin, fluoxetine, diazepam, ethynylestradiol, atorvastatin, norfluoxetine, o-hydroxy atorvastatin, p-hydroxy atorvastatin, risperiodine, testosterone, risperidone, enalapril, simvastatin, simvastatin hydroxyl acid, clofibrate, phthalate esters, primidone, fluoroquinolones, norfloxacin, ofloxacin, ciprofloxacin, tetracycline, doxycycline, estriol, D-norgestrel, clopidogrel, enoxparin, celecoxib, rofecoxib, valdecoxib, omeprazole, esomeprazole, fexofenadine, quetiapine, metoprolol, budesonide, paracetamol, propylphenazone, acetaminophenone, ibuprofen methyl ester, quinolone, macrolide antibiotics, synthetic steroid hormone, loratadine, cetirizine, and mixtures thereof.

28. A method, comprising:
contacting a physiologically active compound-containing stream with at least one of an insoluble and soluble rare earth fixing agent to form an insoluble target material-containing fixing agent comprising at least a portion of the physiologically active target material and the rare earth, wherein the physiologically active compound is other than nitrate, iodine, selenium, and bis(2-ethylhexyl)phthalate wherein the physiologically active compound is selected from the group consisting of prescription drug, over-the-counter therapeutic drug, veterinary drug, fragrance, cosmetic, sun-screen agent, diagnostic agent, nutraceutical, biopharmaceutical active compound, growth enhancing chemical, antimicrobial, estrogenic steroid, antidepressant, selective serotonin reuptake inhibitor, calcium-channel blocker, antiepileptic drug, phenytoin, valproate, carbamazepine, multi-drug transporter, efflux pump, musk aroma chemical, triclosan, genotoxic drug, and mixtures thereof.

29. The method of claim 28, wherein the rare earth is selected from the group consisting of at least one of yttrium, scandium, lanthanum, cerium, praseodymium, neodymium, promethium, samarium, europium, gadolinium, terbium, dysprosium, holmium erbium, thulium, ytterbium, and lutetium and.

30. The method of claim 28, wherein the physiologically active compound comprises one or more of an antipyretics, analgesics, antimalarial drugs, antacids, reflux suppressants, antiflatulents, antidopaminergics, proton pump inhibitors (PPIs), H2-receptor antagonists, cytoprotectants, prostaglandin analogues, laxatives, antispasmodics, antidiarrhoeals, bile acid sequestrants, opioid, β-receptor blockers, calcium channel blockers, diuretics, cardiac glycosides, antiarrhythmics, antianginals, vasoconstrictors, vasodilators, peripheral activators, antihypertensive drugs, ACE inhibitors, angiotensin receptor blockers, α blockers, calcium channel blockers, anticoagulants, heparin, antiplatelet drugs, fibrinolytics, anti-hemophilic factors, haemostatic drugs, atherosclerosis/cholesterol inhibitors, hypolipidaemic agents, statins, hypnotics, anaesthetics, antipsychotics, antidepressants, tricyclic antidepressants, monoamine oxidase inhibitors, selective serotonin reuptake inhibitors (SSRIs), antiemetics, anticonvulsants, antiepileptics, anxiolytics, barbiturates, movement disorder drugs, stimulants, amphetamines, benzodiazepines, cyclopyrrolones, dopamine antagonists, antihistamines, cholinergics, anticholinergics, emetics, cannabinoids, 5-HT (serotonin) antagonists, nonsteroidal anti-inflammatory drugs, opioids and various orphans, paracetamol, tricyclic antidepressants, anticonvulsants, adrenergic neurone blocker, astringent, ocular lubricant, topical anesthetics, sympathomimetics, parasympatholytics, mydriatics, cycloplegics, antibiotics, topical antibiotics, sulfa drugs, aminoglycosides, fluoroquinolones, antiviral drugs, anti-fungal drugs, imidazoles, polyenes, corticosteroids, anti-allergy, mast cell inhibitors, anti-glaucoma, adrenergic agonists, beta-blockers, carbonic anhydrase inhibitors/hyperosmotics, cholinergics, miotics, parasympathomimetics, prostaglandin agonists/prostaglandin inhibitors, nitroglycerin, sympathomimetics, antihistamines, anticholinergics, steroids, local anesthetics, cerumenolyti, bronchodilators, anti-allergics, antitussives, mucolytics, decongestants, Beta2-adrenergic agonists, anticholinergics, androgens, antiandrogens, gonadotropin, human growth hormone, insulin, antidiabetics, sulfonylureas, biguanides, metformin, thiazolidinediones, insulin, thyroid hormones, antithyroid drugs, calcitonin, diphosponate, vasopressin analogues, alkalising agents, quinolones, cholinergics, anticholinergics, anticholinesterases, antispasmodics, 5-alpha reductase inhibitor, selective alpha-1 blockers, sildenafils, fertility medications, ormeloxifene, spermicide, anticholinergics, haemostatic drugs, antifibrinolytics, Hormone Replacement Therapy (HRT), bone regulators, beta-receptor agonists, follicle stimulating hormone, luteinising hormone, LHRH, gamolenic acid, gonadotropin release inhibitor, progestogen, dopamine agonists, oestrogen, prostaglandins, gonadorelin, clomiphene, tamoxifen, Diethylstilbestrol, emollients, anti-pruritics, disinfectants, scabicides, pediculicides, tar products, vitamin A derivatives, vitamin D analogues, keratolytics, abrasives, systemic antibiotics, topical antibiotics, hormones, desloughing agents, exudate absorbents, fibrinolytics, proteolytics, sunscreens, antiperspirants, antibiotics, antileprotics, antituberculous drugs, antimalarials, anthelmintics, amoebicides, antiprotozoals, vaccines, immunoglobulins, immunosuppressants, interferons, monoclonal antibodies, anti-allergics, antihistamines, tonics, iron preparations, parenteral nutritional supplements, vitamins, anti-obesity drugs, anabolic drugs, haematopoietic drugs, food product drugs, barbiturates, HMG-CoA reductase inhibitors, and mixtures thereof.

31. The method of claim 28, wherein the rare earth is selected from the group consisting of at least one of yttrium, scandium, lanthanum, cerium, praseodymium, neodymium, promethium, samarium, europium, gadolinium, terbium, dysprosium, holmium erbium, thulium, ytterbium, and lutetium and wherein the physiologically active target compound comprises one or more of caffeine, acetaminophen, ibuprofen, dimethoprim, trimethoprim, sulfonamide, sulfamethoxazole, diethyl phthalate, cotinine, nicotine, lincomycini, sulfadimethoxine, sulfamethazine, sulfathiazole, tylosin, cholesterol, coprostan-3-ol, dihydrocholesterol, ergosterol, stigmastanol, stigmasterol, bezafibrate, clofibric acid, carbamazepine, diclofenac, naproxen, propranolol, ketoprofen, mefenamic acid, androstenedione, estrone, progesterone, estradiol, pentoxifylline, ethynylestradiol, synthetic estrogen EE2, endogenous estrogen 17β-estradiol (E2) and 17α-ethinylstradiol (EE2), estrone, meprobamate, phenytoin, ethinyl estradiol, mestranol, norethindrone, erythromycine, atenolol, triclosan, bisphenol A, nonylphenol, DEET, iopromide, TCEP, roxithromycin, erythromycin-H₂O, gemfibrozil, meprobamate, phenytoin, fluoxetine, diazepam, ethynylestradiol, atorvastatin, norfluoxetine, o-hydroxy atorvastatin, p-hydroxy atorvastatin, risperiodine, testosterone, risperidone, enalapril, simvastatin, simvastatin hydroxyl acid, clofibrate, phthalate esters, primidone, fluoroquinolones, norfloxacin, ofloxacin, ciprofloxacin, tetracycline, doxycycline, estriol, D-norgestrel, clopidogrel, enoxparin, celecoxib, rofecoxib, valdecoxib, omeprazole, esomeprazole, fexofenadine, quetiapine, metoprolol, budesonide, paracetamol, propylphenazone, acetaminophenone, ibuprofen methyl ester, quinolone, macrolide antibiotics, synthetic steroid hormone, loratadine, cetirizine, and mixtures thereof.

32. The method of claim 28, wherein the rare earth is selected from the group consisting of at least one of yttrium, scandium, lanthanum, cerium, praseodymium, neodymium, promethium, samarium, europium, gadolinium, terbium, dysprosium, holmium erbium, thulium, ytterbium, lutetium, and mixtures thereof.

33. The method of claim 32, wherein the at least one of an insoluble and soluble rare earth fixing agent comprises cerium.

34. The method of claim 33, wherein the at least one of an insoluble and soluble rare earth fixing agent comprises at least one of cerium (IV) oxide (CeO₂) and cerium (III) oxide (Ce₂O₃).

35. The method of claim 22, wherein the at least one of a soluble and insoluble rare earth fixing agent comprises a trivalent rare earth selected from the group consisting essentially of lanthanum, cerium, praseodymium, neodymium, promethium, samarium, europium, gadolinium, terbium, dysprosium, holmium erbium, thulium, ytterbium and lutetium.

36. The method of claim 22, wherein the at least one of a soluble and insoluble rare earth fixing agent comprises a plurality of different rare earths having differing oxidation states.

37. The method of claim 22, wherein the at least one of a soluble and insoluble rare earth fixing agent comprises insoluble and soluble rare earth compounds and wherein the fixing agent comprises an insoluble form of cerium.

38. The method of claim 22, wherein the at least one of a soluble and insoluble rare earth fixing agent comprises an insoluble rare earth fixing agent having a plurality of different rare earths having differing oxidation states.

39. The method of claim 28, wherein the at least one of an insoluble and soluble rare earth fixing agent comprises an insoluble rare earth fixing agent having a plurality of different rare earths having differing oxidation states.

40. The method of claim 22, wherein the at least one of a soluble and insoluble rare earth fixing agent comprises an insoluble rare earth fixing agent.

41. The method of claim 28, wherein the at least one of an insoluble and soluble rare earth fixing agent comprises a soluble rare earth fixing agent.

42. The method of claim 22, wherein the physiologically active target material is selected from the group consisting of prescription drug, over-the-counter therapeutic drug, veterinary drug, fragrance, cosmetic, sun-screen agent, diagnostic agent, nutraceutical, biopharmaceutical active compound, growth enhancing chemical, estrogenic steroid, antidepressant, selective serotonin reuptake inhibitor, calcium-channel blocker, antiepileptic drug, phenytoin, valproate, carbamazepine, multi-drug transporter, efflux pump, musk aroma chemical, triclosan, genotoxic drug, and mixtures thereof.

43. The method of claim 28, wherein the physiologically active target material is selected from the group consisting of prescription drug, over-the-counter therapeutic drug, veterinary drug, fragrance, cosmetic, sun-screen agent, diagnostic agent, nutraceutical, biopharmaceutical active compound, growth enhancing chemical, estrogenic steroid, antidepressant, selective serotonin reuptake inhibitor, calcium-channel blocker, antiepileptic drug, phenytoin, valproate, carbamazepine, multi-drug transporter, efflux pump, musk aroma chemical, triclosan, genotoxic drug, and mixtures thereof.
